(19) United States
(12) Patent Application Publication
(10) Pub. No.: US 2009/0209422 A1
(43) Pub. Date: Aug. 20, 2009

(54) Insecticidal Substituted Aminoalkyl Heterocyclic and Heteroaryl Derivatives

(75) Inventors: John A. Dixson, Newtown, PA (US); George Theodoridis, Princeton, NJ (US); Zeinab M. Elshenawy, Holland, PA (US); Benjamin J. Dugan, Glen Mills, PA (US); Manorama M. Patel, West Windsor, NJ (US); John W. Lyga, Basking Ridge, NJ (US); Stephen F. Donovan, Revere, PA (US); Ping Ding, Grafton, MA (US)

Correspondence Address: STERNE, KESSLER, GOLDSTEIN & FOX P.L.L.C., 1100 NEW YORK AVENUE, N.W., WASHINGTON, DC, 20005, US

(73) Assignee: Bayer CropScience AG, Monheim (DE)

(21) Appl. No.: 11/913,185

(22) PCT Filed: May 2, 2006
(86) PCT No.: PCT/US06/17121

§ 371 Date: Jun. 30, 2008

Related U.S. Application Data
(60) Provisional application No. 60/677,378, filed on May 3, 2005.

(51) Int. Cl. A01N 59/04; A01N 43/50; A01N 57/16; A01N 43/707; A01N 43/56

(52) U.S. Cl. 504/101; 514/401; 514/94; 514/383; 514/406; 514/93; 504/197; 504/274; 504/275

(57) ABSTRACT

Certain substituted aminoalkyl heteroaryl and heterocyclyl derivatives have provided unexpected insecticidal and acaricidal activity. These compounds are represented by formula I: wherein R, R¹, R², R³ and R⁴ are folly described herein. In addition, compositions comprising an insecticidally effective amount of at least one compound of formula I, and optionally, an effective amount of at least one of an additional compound, with at least one insecticidally compatible carrier are also disclosed; along with methods of controlling insects comprising applying said compositions to a locus where insects are present or are expected to be present.

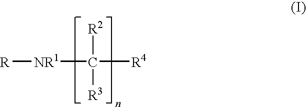

This application claims the benefit of U.S. Provisional Application No. 60/677,378 filed May 3, 2005.

### FIELD OF THE INVENTION

The present invention generally relates to pesticidal compounds and their use in controlling insects and acarids. In particular, it pertains to compositions of pesticidal substituted aminoalkyl heterocyclic and heteroaryl derivatives and agriculturally acceptable salts thereof, and methods for their use in controlling insects and acarids.

### BACKGROUND OF THE INVENTION

It is well known that insects in general can cause significant damage, not only to crops grown in agriculture, but also, for example, to structures and turf where the damage is caused by soil-borne insects, such as termites and white grubs. Such damage may result in the loss of millions of dollars of value associated with a given crop, turf or structure. Although there are many orders of insects that can cause significant crop damage, insects, for example, of the order “Homoptera” are of major importance. The order Homoptera includes, for example, aphids, leafhoppers, cicadas, whiteflies, and mealybugs. Homoptera have piercing/sucking mouthparts, enabling them to feed by withdrawing sap from vascular plants. Insect damage from Homoptera is manifested in several different ways, other than damage caused by direct feeding. For example, many species excrete honeydew, a sticky waste product that adheres to plants upon which the insect feeds and lives. Honeydew alone causes cosmetic injury to crop plants. Sooty molds will often grow on honeydew, making food products or ornamental plants look unappealing, thereby reducing their cosmetic and economic value. Some Homoptera have toxic saliva that is injected into plants while they are feeding. The saliva can cause plant damage through disfigurement and in some instances plant death. Homoptera can also vector disease-causing pathogens. Unlike direct damage, it does not take a large number of disease-vectoring insects to cause considerable damage to crop plants.

Thus, there is a continuing demand for new insecticides, and for new acaricides that are safer, more effective, and less costly. Insecticides and acaricides are useful for controlling insects and acarids which may otherwise cause significant damage both above and below the soil level to crops such as wheat, corn, soybeans, potatoes, and cotton to name a few. For crop protection, insecticides and acaricides are desired which can control the insects and acarids without damaging the crops, and which have no deleterious effects to mammals and other living organisms.

A number of patents disclose some substituted phenyl aminoalkyl imidazole and 2-imidazoline compounds that are reported to have pesticidal activity. For example, Canadian Patent 1,109,787 discloses ectoparasiticidal compositions containing imidazoline derivatives and their acid addition salts affective against ectoparasites, such as ticks and mites. The compositions contain a compound of formula I:

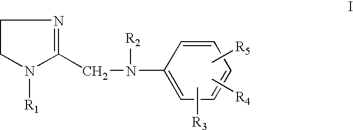

wherein
R₁ represents hydrogen or alkyl of 1 to 10 carbon atoms,
R₂ represents hydrogen, alkyl having 1 to 10 carbon atoms, or phenyl optionally substituted by alkyl having 1 to 5 carbon atoms, alkoxy having 1 to 5 carbon atoms, thioalkyl having 1 to 5 carbon atoms, hydroxyl, halogen, nitro, cyano or the trifluoromethyl group,
R₃, R₄ and R₅ independently of one another represent hydrogen, alkyl having 1 to 5 carbon atoms, alkoxy having 1 to 5 carbon atoms, alkylthio having 1 to 5 carbon atoms, hydroxyl, halogen, nitro, cyano or the trifluoromethyl group, or
R₃ and R₄ in neighboring position together represent the 1,4-butadienyl group, whilst R₅ has one of the given meanings,
   or at least one acid addition salt of the compounds of formula I.

U.S. Pat. No. 5,128,361 discloses imidazoline derivatives as the active agents for systemic combating of ectoparasites in host animals containing a compound of formula I:

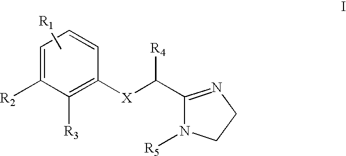

in which
R¹ denotes hydrogen, (C₁-C₅)alkyl, (C₁-C₃) halogenoalkyl or halogen;
R² and R³ independently of one another denote (C₁-C₅)alkyl, (C₂-C₅)alkenyl, (C₂-C₅)alkynyl, (C₃-C₇) cycloalkyl, (C₃-C₇) cycloalkenyl, (C₁-C₃) halogenoalkyl, halogen, cyano, nitro, (C₁-C₅)alkoxy, (C₁-C₃)alkoxy-(C₁-C₃)alkyl, (C₁-C₃) halogenoalkoxy or (C₁-C₃)alkylthio, or R² and R³ together form a polymethylene chain having 2 to 5 carbon atoms;
R⁴ denotes hydrogen, (C₁-C₁₀)alkyl, (C₂-C₅)alkenyl or (C₃-C₇) cycloalkyl;
R⁵ denotes (C₁-C₁₀)alkyl, (C₃-C₅)alkenyl, (C₃-C₅)alkynyl, (C₃-C₇) cycloalkyl, (C₃-C₇) cycloalkenyl, (C₁-C₃) halogenoalkyl or (C₁-C₃)alkoxy-(C₁-C₃)alkyl;
X denotes oxygen, sulfur, or an —NR⁶— group; and
R⁶ denotes hydrogen, (C₁-C₅)alkyl, (C₃-C₅)alkenyl, (C₃-C₅)alkynyl, (C₃-C₇) cycloalkyl, (C₃-C₇) cycloalkenyl, (C₁-C₃) halogenoalkyl or (C₁-C₃)alkoxy-(C₁-C₃)alkyl,
   or biologically tolerated acid addition salts thereof.

German Offenlegungsschrift DE 3407072 A1 discloses substituted aryl aminomethyl-2-imidazoline derivatives for the control of parasitic bee mites of the following formula:

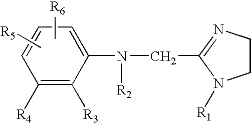

in which
R₁ is hydrogen or (C₁-C₅)alkyl,
R₂ is hydrogen, (C₁-C₅)alkyl, or alkoxyalkyl with 1 to 5 carbon atoms in the alkyl group,
R₃, R₄, R₅, and R₆ are selected from hydrogen, (C₁-C₅)alkyl, (C₁-C₅)alkoxy or halogen,
and acid addition salts thereof.

U.S. Pat. No. 4,226,876 discloses compounds of formula (I)

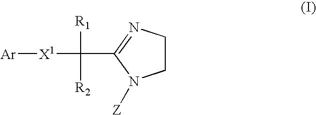

wherein
Ar is an unsubstituted or mono-, di- or tri-substituted phenyl radical in which the substituents are the same or different and are selected from alkyl, alkoxy, halogen, hydroxy, cyano, amino, trifluoromethyl or nitro and in which any two adjacent carbon atoms on the phenyl ring may optionally be joined by a carbon chain having 3 or four carbon atoms;
X¹ is O or NH;
R¹ and R² are the same or different and are hydrogen or alkyl; and
Z is a group SOₙR⁸ or a group

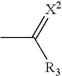

in which X² is O, S or NR⁴;

R³ is alkyl, aryl, alkyloxy, aryloxy or NR⁵R⁶;

R⁴ is alkyl, aryl, alkyloxy, aryloxy, alkylthio, arylthio or NR⁵R⁶;

R⁵ and R⁶ are the same or different and are hydrogen, alkyl, aryl, COR⁷ or SO₂R⁷;

R⁷ is alkyl, aryl, alkyloxy or aryloxy;

n is 1 or 2;

R⁸ is alkyl, aryl, or NR⁹R¹⁰; and

R⁹ and R¹⁰ are the same or different and are hydrogen, alkyl or aryl. Methods of making such compounds, pesticidal formulations containing them and their pesticidal use against arthropods of the Order “Acarina” are also disclosed.

U.S. Pat. No. 4,379,147 discloses substituted 2-(anilinomethyl)-2-imidazoline derivatives of the formula

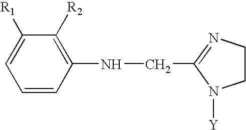

wherein
R₁ and R₂ independently of one another are each a chlorine atom or the methyl group,
Y is the group

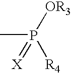

### or —CH═N—R₅,

in which
R₃ is methyl or ethyl,
R₄ is alkyl having 1 to 4 carbon atoms, alkoxy having 1 or 2 carbon atoms, alkylthio having 1 to 4 carbon atoms, or phenyl,
X is an oxygen atom or a sulfur atom, and
R₅ is an unsubstituted or substituted pyridinyl group which is linked by way of one of its carbon atoms, to the main part of the molecule, and which has substituents selected from the group comprising halogen and alkyl having 1 to 4 carbon atoms, including the acid addition salts thereof, and processes for producing the novel compounds.
   The resulting compounds and compositions containing them are reported to be effective against members of the order Acarina, and against animal and plant lice, as well as against members of the Calliphoridae family.

International Publication Number WO 2004/014898 A1 discloses substituted phenyl-amino-methyl-2-imidazole compounds as intermediates to pharmaceutically active benzopyran derivatives substituted with secondary amines.

Izvestiya Akademii Nauk, Seriya Khimicheskaya (1994), (3), 472-479 discloses a process for the monoacylation of the imidazoline ring of 2((arylamino)methyl)-imidazolines.

Journal of Medicinal Chemistry 1983, 26, 1769-1772 discloses the synthesis of some substituted 2-(phenylaminomethyl)imidazolines and the alpha-adrenergic activities of these compounds.

There is no disclosure or suggestion in any of the above-referenced patents or publications of the insecticidal activity of the compounds of the present invention against members of the suborder “Homoptera”. In addition, there is no disclosure or suggestion in any of the above-referenced patents or publications of the structures of the novel compounds of the present invention.

### SUMMARY OF THE INVENTION

The present invention generally relates to insecticidal and acaricidal compositions of substituted aminoalkyl heterocyclic and heteroaryl derivatives and to certain new and useful compounds, namely certain substituted aminoalkyl heterocyclic and heteroaryl derivatives that are surprisingly active in the control of insects and acarids when used in the insecticidal and acaricidal compositions and methods of this invention. The insecticidal and acaricidal compositions of the present invention are comprised of at least one of an insecticidally effective amount of a compound of formula I and at least one insecticidally compatible carrier therefor, wherein the compound of formula I is:

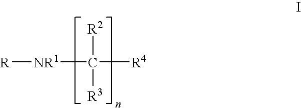

wherein
R is aryl or heteroaryl in which the aryl and heteroaryl moieties are optionally substituted with one or more halogen, hydroxy, alkyl, haloalkyl, alkoxy, haloalkoxy, alkenyl, haloalkenyl, alkynyl, haloalkynyl, cyano, nitro, aryl, heteroaryl, alkoxyalkyl, alkoxyalkoxyalkyl, cycloalkyl, cyanoalkyl, formal, alkoxycarbonyl, acetyl, alkylcarbonyl, dialkylphosphonato, amino, mono- and dialkylamino, cycloalkylamino, (cycloalkyl)(alkyl)amino, alkylthio, alkylsulfonyl, alkylsulfinylalkyl, alkylsulfonylalkyl, alkenylcarbonyl, benzyl, mono- and dialkylaminocarbonyl, trialkylsilyl and alkylthiocarbonyl;
n is an integer selected from 1, 2 or 3;
R² and R³ are independently selected from hydrogen, alkyl, haloalkyl or cyano;
R⁴ is selected from

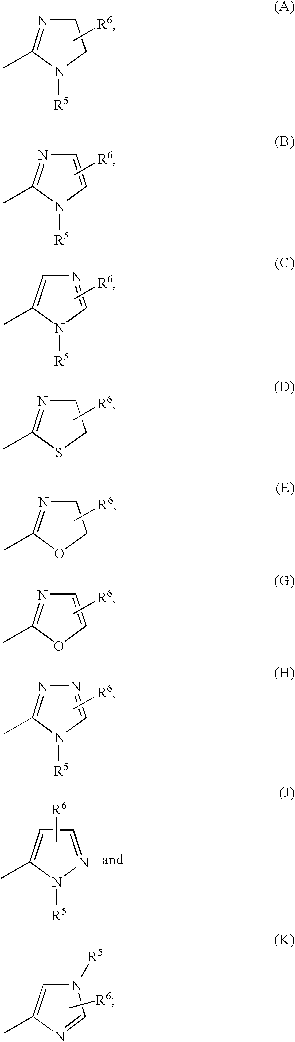

R⁶ is hydrogen, halogen or alkyl;
R¹ and R⁵ are independently selected from hydrogen, alkyl, alkoxyalkyl, cyano, hydroxycarbonylalkyl, benzyloxycarbonylalkoxy,

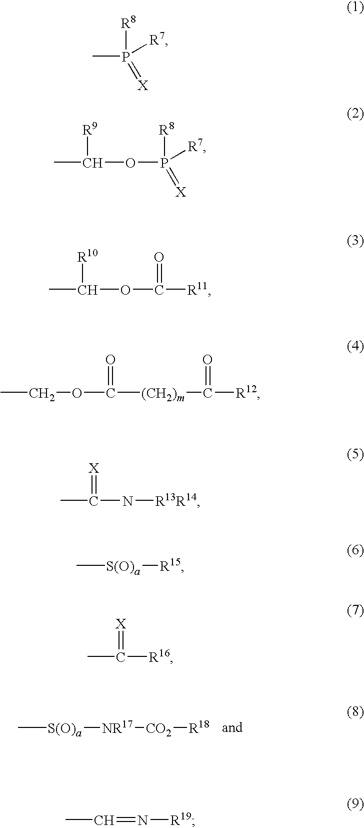

where
X is oxygen or sulphur;
R⁷ and R⁸ are independently selected from hydroxy, alkyl, alkoxy, alkylthio, dialkylamino and arylalkoxy;
R⁹ and R¹⁰ are hydrogen or alkyl;
R¹¹ is alkyl or aryl;
m is an integer selected from 1, 2, 3, or 4;
R¹² is hydrogen, alkyl, alkoxy or arylalkyl;
R¹³ and R¹⁴ are independently selected from hydrogen, alkyl, haloalkyl, cycloalkyl, cyanoalkyl, alkylcarbonyl, alkoxycarbonyl, alkoxycarbonylalkyl, alkoxyalkyl, alkylthioalkyl, alkylsulfinylalkyl, alkylsulfonylalkyl, mono or dialkylaminocarbonylalkyl, aminoalkyl, mono or dialkylaminoalkyl, arylcarbonyl aryl, and aryl optionally substituted with halogen or alkoxycarbonylalkyl;
a is an integer selected from 0, 1 or 2;
R¹⁵ is alkyl, haloalkyl, aryl optionally substituted with halogen or mono- or dialkylamino;
R¹⁶ is hydrogen, alkyl, alkoxy, alkylthio, alkylamino, alkylaminothio, aryl optionally substituted with halogen, benzyloxycarbonylalkoxy, alkynyloxy, alkoxycarbonylalkyl or cycloalkoxy optionally substituted with one or more alkyl groups;
R¹⁷ and R¹⁸ are independently selected from hydrogen or alkyl;
R¹⁹ is hydrogen, alkyl, haloalkyl, hydroxy, alkoxy, haloalkoxy, cyano, pyridinyl or 2-thiazolinyl;
   and
   agriculturally acceptable salts thereof.

The present invention also includes compositions containing a pesticidally effective amount of at least one compound of formula I, and optionally, an effective amount of at least one additional compound, with at least one pesticidally compatible carrier.

The present invention also includes methods of controlling insects in an area where control is desired, which comprise applying a pesticidally effective amount of the above composition to the locus of crops, buildings, soil or other areas where insects are present or are expected to be present.

### DETAILED DESCRIPTION OF THE INVENTION

The present invention generally relates to insecticidal and acaricidal compositions of substituted aminoalkyl heteroaryl and heterocyclyl derivatives and to certain new and useful compounds, namely certain substituted aminoalkyl heteroaryl and heterocyclyl derivatives that are surprisingly active in the control of insects and acarids when used in the insecticidal and acaricidal compositions and methods of this invention. The insecticidal and acaricidal compositions of the present invention are comprised of at least one of an insecticidally effective amount of a compound of formula I and at least one insecticidally compatible carrier therefor, wherein the compound of formula I is:

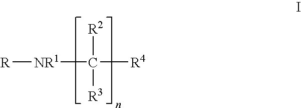

wherein
R is aryl or heteroaryl in which the aryl and heteroaryl moieties are optionally substituted with one or more halogen, hydroxy, alkyl, haloalkyl, alkoxy, haloalkoxy, alkenyl, haloalkenyl, alkynyl, haloalkynyl, cyano, nitro, aryl, heteroaryl, alkoxyalkyl, alkoxyalkoxyalkyl, cycloalkyl, cyanoalkyl, formal, alkoxycarbonyl, acetyl, alkylcarbonyl, dialkylphosphonato, amino, mono- and dialkylamino, cycloalkylamino, (cycloalkyl)(alkyl)amino, alkylthio, alkylsulfonyl, alkylsulfinylalkyl, alkylsulfonylalkyl, alkenylcarbonyl, benzyl, mono- and dialkylaminocarbonyl, trialkylsilyl and alkylthiocarbonyl;
n is an integer selected from 1, 2 or 3;
R² and R³ are independently selected from hydrogen, alkyl, haloalkyl or cyano;
R⁴ is selected from

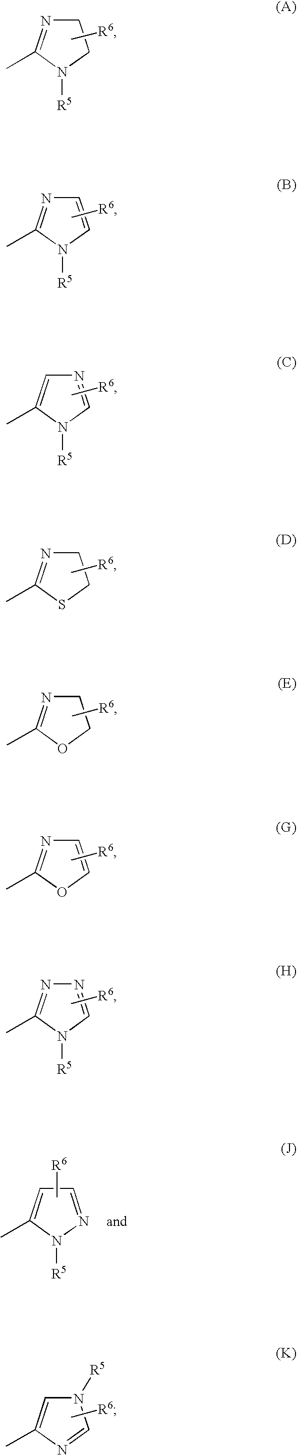

R⁶ is hydrogen, halogen or alkyl;
R¹ and R⁵ are independently selected from hydrogen, alkyl, alkoxyalkyl, cyano, hydroxycarbonylalkyl, benzyloxycarbonylalkoxy,

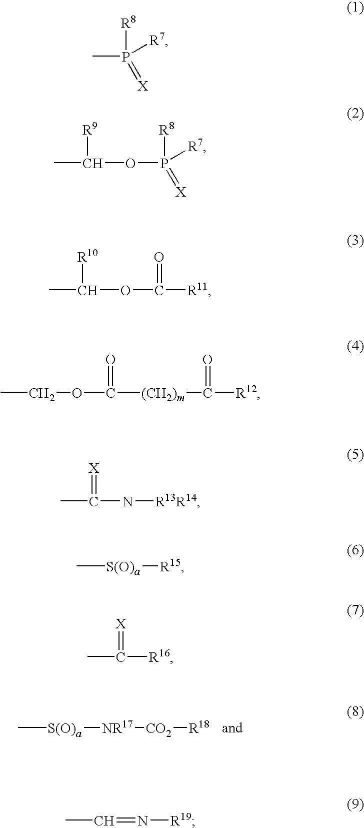

where
X is oxygen or sulphur;
R⁷ and R⁸ are independently selected from hydroxy, alkyl, alkoxy, alkylthio, dialkylamino and arylalkoxy;
R⁹ and R¹⁰ are hydrogen or alkyl;
R¹¹ is alkyl or aryl;
m is an integer selected from 1, 2, 3, or 4;
R¹² is hydrogen, alkyl, alkoxy or arylalkyl;
R¹³ and R¹⁴ are independently selected from hydrogen, alkyl, haloalkyl, cycloalkyl, cyanoalkyl, alkylcarbonyl, alkoxycarbonyl, alkoxycarbonylalkyl, alkoxyalkyl, alkylthioalkyl, alkylsulfinylalkyl, alkylsulfonylalkyl, mono or dialkylaminocarbonylalkyl, aminoalkyl, mono or dialkylaminoalkyl, arylcarbonyl aryl, and aryl optionally substituted with halogen or alkoxycarbonylalkyl;
a is an integer selected from 0, 1 or 2;
R¹⁵ is alkyl, haloalkyl, aryl optionally substituted with halogen or mono- or dialkylamino;
R¹⁶ is hydrogen, alkyl, alkoxy, alkylthio, alkylamino, alkylaminothio, aryl optionally substituted with halogen, benzyloxycarbonylalkoxy, alkynyloxy, alkoxycarbonylalkyl or cycloalkoxy optionally substituted with one or more alkyl groups;
R¹⁷ and R¹⁸ are independently selected from hydrogen or alkyl;
R¹⁹ is hydrogen, alkyl, haloalkyl, hydroxy, alkoxy, haloalkoxy, cyano, pyridinyl or 2-thiazolinyl;
   and
   agriculturally acceptable salts thereof.

More specifically, preferred species of this invention are those insecticidal compositions comprised of compounds of formula Ia:

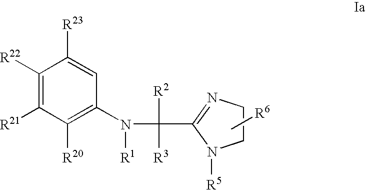

wherein
R¹ is hydrogen;
R² is selected from hydrogen and (C₁-C₂)alkyl;
R³ is hydrogen;
R⁶ is hydrogen or (C₁-C₂)alkyl;
R⁵ is selected from hydrogen, cyano, (C₁-C₂)alkoxy(C₁-C₂)alkyl,

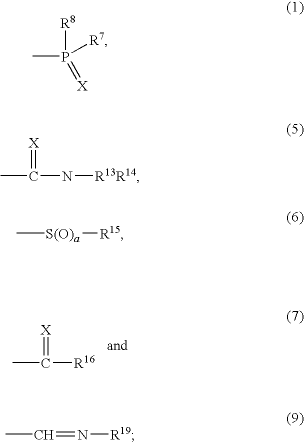

where
X is oxygen or sulphur;
R⁷ and R⁸ are (C₁-C₂)alkoxy or di(C₁-C₂)alkylamino;
R¹³ is hydrogen;
R¹⁴ is phenyl substituted with 1 to 2 chlorine atoms;
a is 2;
R¹⁵ is (C₁-C₂)haloalkyl;
R¹⁶ is hydrogen, (C₃-C₅)alkyl, methoxy, (C₁-C₂)alkoxycarbonyl(C₁-C₂)alkyl or phenyl optionally substituted in the 3-position with fluorine, in the 4-position with (C₁-C₂)haloalkyl or (C₁-C₂)haloalkoxy, in the 3- and/or 4-position with chlorine or in the 3- or 4-position with (C₁-C₂)alkoxy;
R¹⁹ is (C₁-C₂)alkyl or (C₁-C₂)alkoxy;
   R²⁰ is hydrogen, halogen or (C₁-C₂)alkyl;
   R²¹ is hydrogen, halogen, (C₁-C₂)alkyl or (C₁-C₂)alkoxy;
   R²² is hydrogen or halogen;
   R²³ is hydrogen or (C₁-C₂)alkyl;
   provided that:
   at least one of R²⁰-R²³ is other than hydrogen;
when R¹, R², R³ and R⁶ are hydrogen, R⁵ is group (7) in which X is oxygen and R is 2,3-dichlorophenyl, then R¹⁶ is other than 1-methylpropyl or methoxy;
when R¹, R², R³ and R⁶ are hydrogen, R⁵ is group (7) in which X is oxygen and R is 2,3-dimethylphenyl, then R¹⁶ is other than methoxycarbonylmethyl; and
when R¹, R², R³, R⁵ and R⁶ are hydrogen, then R is other than 2-methylphenyl or 4-chloro-2-methylphenyl and the hydrochloride salt thereof.

More preferred species in this aspect of the invention are those insecticidal compositions comprised of compounds of formula Ia where:
1) R²⁰ and R²¹ are chlorine and i) R⁵ is cyano; ii) R⁵ is ethoxymethyl; and iii) R⁵ is hydrogen; and
2) R²⁰ and R²¹ are chlorine, R⁵ is group (7), X is oxygen and i) R¹⁶ is hydrogen; and ii) R¹⁶ is 4-trifluoromethoxyphenyl.

In another aspect of this invention, preferred species are those insecticidal compositions comprised of formula Ib:

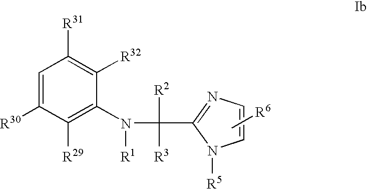

wherein
R¹ is hydrogen, group (5) in which X is sulfur, R¹³ is hydrogen and R¹⁴ is (C₁-C₂)alkyl or group (7) in which X is oxygen and R¹⁶ is hydrogen or (C₁-C₄)alkoxy;
R² and R³ are hydrogen;
R⁶ is hydrogen;
R⁵ is selected from hydrogen, (C₁-C₂)alkoxy(C₁-C₂)alkyl, benzyloxycarbonyl(C₁-C₄)alkoxy,

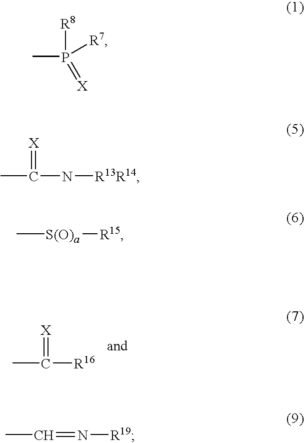

where
X is oxygen or sulphur;
R⁷ and R⁸ are (C₁-C₂)alkoxy or di(C₁-C₂)alkylamino;
R¹³ is hydrogen or (C₁-C₂)alkyl;
R¹⁴ is hydrogen, (C₁-C₅)alkyl, (C₃-C₆)cycloalkyl, (C₁-C₂)alkoxy(C₁-C₂)alkyl, cyano(C₁-C₂)alkyl, (C₁-C₂)alkoxycarbonyl(C₁-C₂)alkyl;
a is 2;
R¹⁵ is (C₁-C₂)haloalkyl, di(C₁-C₂)alkylamino or pentafluorophenyl;
R¹⁶ is hydrogen, (C₁-C₅)alkyl, (C₁-C₅)alkoxy, (C₁-C₂)alkylamino, pentafluorophenyl, (C₃-C₅)alkynyl or benzyloxycarbonyl(C₁-C₄)alkoxy; and
R¹⁹ is (C₁-C₂)alkyl or alkoxy;
R²⁹ and R³⁰ are independently selected from halogen or (C₁-C₂)alkyl; and
R³¹ and R³² are each hydrogen or halogen.

More preferred species in this aspect of the invention are those insecticidal compositions comprised of compounds of formula Ib where
1) R²⁹ and R³⁰ are methyl and R⁵ is group (1), X is oxygen and R⁷ and R⁸ are ethoxy;
2) R²⁹ and R³⁰ are methyl and R⁵ is group (7), X is oxygen and i) R¹⁶ is alkyl of 1 to 5 carbon atoms; ii) R¹⁶ is alkoxy of 2 to 4 carbon atoms; and iii) R¹⁶ is 3-propynyloxy; and
3) R⁵ is hydrogen and i) R²⁹ and R³⁰ are methyl; and ii) R²⁹ and R³⁰ are chlorine.

Another aspect of this invention are those insecticidal compositions comprised of formula Ic:

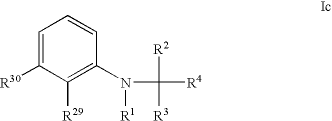

wherein
R¹, R² and R³ are hydrogen;
R⁴ is selected from

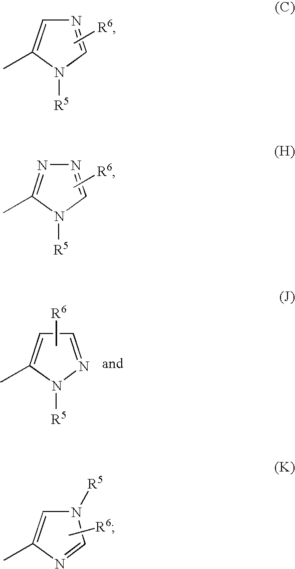

R⁶ is hydrogen;
R⁵ is selected from hydrogen,

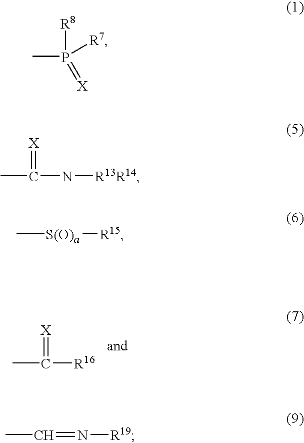

where

X is oxygen or sulphur;

R⁷ and R⁸ are (C₁-C₂)alkoxy;

R¹³ is hydrogen;

R¹⁴ is (C₁-C₂)alkyl;

a is 2;

R¹⁵ is di(C₁-C₂)alkylamino;

R¹⁶ is hydrogen, (C₁-C₂)alkyl or (C₁-C₂)alkoxy;

R¹⁹ is (C₁-C₂)alkyl or (C₁-C₂)alkoxy; and

R²⁹ and R³⁰ are independently selected from halogen and (C₁-C₂)alkyl.

Certain of the substituted aminoalkyl heteroaryl and heterocyclyl derivatives, useful in the compositions of the present invention, are novel compounds. Many of these compounds are represented by formula Id:

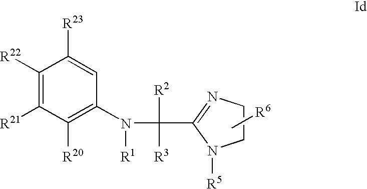

wherein
R¹ is hydrogen;
R² is selected from hydrogen and (C₁-C₂)alkyl;
R³ is hydrogen;
R⁶ is hydrogen or (C₁-C₂)alkyl;
R⁵ is selected from cyano, (C₁-C₂)alkoxy(C₁-C₂)alkyl,

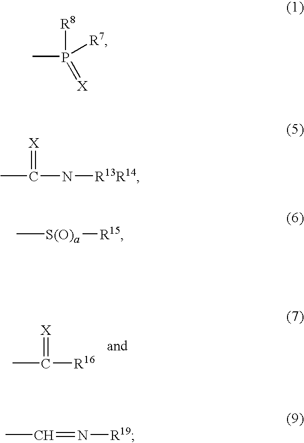

where
X is oxygen or sulphur;
R⁷ and R⁸ are (C₁-C₂)alkoxy or di(C₁-C₂)alkylamino;
R¹³ is hydrogen;
R¹⁴ is phenyl substituted with 1 to 2 chlorine atoms;
a is 2;
R¹⁵ is (C₁-C₂)haloalkyl;
R¹⁶ is hydrogen, (C₃-C₅)alkyl, methoxy, (C₁-C₂)alkoxycarbonyl(C₁-C₂)alkyl or phenyl optionally substituted in the 3-position with fluorine, in the 4-position with (C₁-C₂)haloalkyl or (C₁-C₂)haloalkoxy, in the 3- and/or 4-position with chlorine or in the 3- or 4-position with (C₁-C₂)alkoxy;
R¹⁹ is (C₁-C₂)alkyl or (C₁-C₂)alkoxy;
R²⁰ is hydrogen, halogen or (C₁-C₂)alkyl;
R²¹ is hydrogen, halogen, (C₁-C₂)alkyl or (C₁-C₂)alkoxy;
R²² is hydrogen or halogen;
R²³ is hydrogen or (C₁-C₂)alkyl;
   and
   agriculturally acceptable salts thereof;
   provided that:
at least one of R²⁰-R²³ is other than hydrogen;
when R¹, R², R³ and R⁶ are hydrogen, R⁵ is group (1) in which X is oxygen and R⁷ and R⁸ are alkoxy, then R is other than 2,3-dichlorophenyl and 2,3-dimethylphenyl;
when R¹, R², R³ and R⁶ are hydrogen, R⁵ is group (5) in which X is oxygen, R¹³ is hydrogen and R¹⁴ is phenyl substituted with halogen, then R is other than 2-fluorophenyl and 2,3-dimethylphenyl;
when R¹, R², R³ and R⁶ are hydrogen and R⁵ is methoxyethyl then R is other than 2,3-dimethylphenyl;
when R¹, R², R³ and R⁶ are hydrogen, R⁵ is group (7) in which X is oxygen and R is 2,3-dichlorophenyl, then R¹⁶ is other than 1-methylpropyl or methoxy; and
when R¹, R², R³ and R⁶ are hydrogen, R⁵ is group (7) in which X is oxygen and R is 2,3-dimethylphenyl, then R¹⁶ is other than methoxycarbonylmethyl.

Other substituted aminoalkyl heteroaryl and heterocyclyl derivatives, useful in the compositions of the present invention, are novel compounds. These compounds are represented by formula Ie:

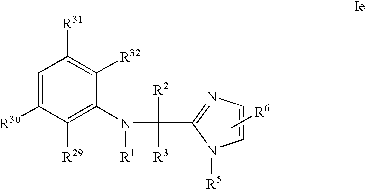

wherein
R¹ is hydrogen, group (5) in which X is sulfur, R¹³ is hydrogen and R¹⁴ is (C₁-C₂)alkyl or group (7) wherein X is oxygen and R¹⁶ is hydrogen or (C₁-C₄)alkoxy;
R² and R³ are hydrogen;
R⁶ is hydrogen;
R⁵ is selected from hydrogen, (C₁-C₂)alkoxy(C₁-C₂)alkyl, benzyloxycarbonyl(C₁-C₄)alkoxy,

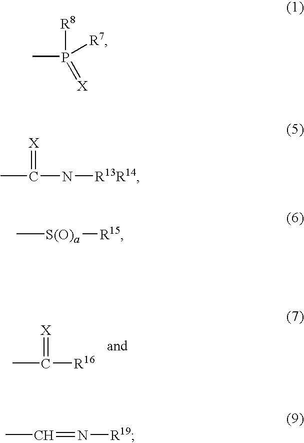

where
X is oxygen or sulphur;
R⁷ and R⁸ are selected from (C₁-C₂)alkyl, (C₁-C₂)alkoxy and di(C₁-C₂)alkylamino;
R¹³ is hydrogen or (C₁-C₂)alkyl;
R¹⁴ is hydrogen, (C₁-C₅)alkyl, (C₃-C₆)cycloalkyl, (C₁-C₂)alkoxy(C₁-C₂)alkyl, cyano(C₁-C₂)alkyl, (C₁-C₂)alkoxycarbonyl(C₁-C₂)alkyl;
a is 2;
R¹⁵ is (C₁-C₂)haloalkyl, di(C₁-C₂)alkylamino or pentafluorophenyl;
R¹⁶ is hydrogen, (C₁-C₅)alkyl, (C₁-C₅)alkoxy, (C₁-C₂)alkylamino, pentafluorophenyl, (C₃-C₅)alkynyl or benzyloxycarbonyl(C₁-C₄)alkoxy; and
R¹⁹ is (C₁-C₂)alkyl or alkoxy;
R²⁹ and R³⁰ are independently selected from halogen or (C₁-C₂)alkyl; and
R³¹ and R³² are each hydrogen or halogen;
   and
   agriculturally acceptable salts thereof;
   provided that:
when R¹, R², R³, R⁵ and R⁶ are hydrogen, then R is other than 2,3-dimethylphenyl or 3-chlorophenyl.

Additional substituted aminoalkyl heteroaryl and heterocyclyl derivatives, useful in the compositions of the present invention, are novel compounds. These compounds are represented by formula If:

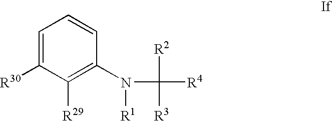

wherein
R¹, R² and R³ are hydrogen;
R⁴ is selected from

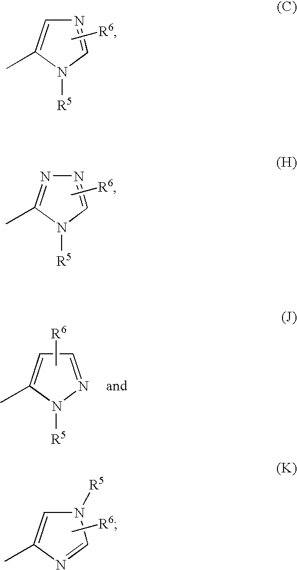

R⁶ is hydrogen;
R⁵ is selected from hydrogen,

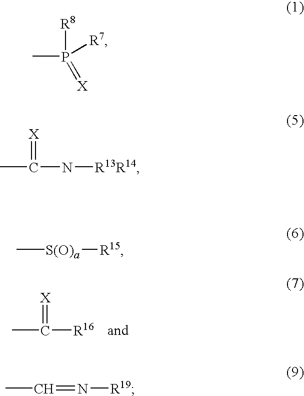

where

X is oxygen or sulphur;

R⁷ and R⁸ are (C₁-C₂)alkoxy;

R¹³ is hydrogen;

R¹⁴ is (C₁-C₂)alkyl;

a is 2;

R¹⁵ is di(C₁-C₂)alkylamino;

R¹⁶ is hydrogen, (C₁-C₂)alkyl or (C₁-C₂)alkoxy;

R¹⁹ is (C₁-C₂)alkyl or (C₁-C₂)alkoxy; and

R²⁹ and R³⁰ are independently selected from halogen and (C₁-C₂)alkyl;

and
agriculturally acceptable salts thereof.

In addition, in certain cases the compounds of the present invention may possess asymmetric centers, which can give rise to optical enantiomorphs and diastereomers. The compounds may exist in two or more forms, i.e., polymorphs, which are significantly different in physical and chemical properties. The compounds of the present invention may also exist as tautomers, in which migration of a hydrogen atom within the molecule results in two or more structures, which are in equilibrium. The compounds of the present invention may also possess acidic or basic moieties, which may allow for the formation of agriculturally acceptable salts or agriculturally acceptable metal complexes.

This invention includes the use of such enantiomorphs, polymorphs, tautomers, salts and metal complexes. Agriculturally acceptable salts and metal complexes include, without limitation, for example, ammonium salts, the salts of organic and inorganic acids, such as hydrochloric acid, sulfonic acid, ethanesulfonic acid, trifluoroacetic acid, methylbenzenesulfonic acid, phosphoric acid, gluconic acid, pamoic acid, and other acid salts, and the alkali metal and alkaline earth metal complexes with, for example, sodium, potassium, lithium, magnesium, calcium, and other metals.

The methods of the present invention are predicated on causing an insecticidally effective amount of a compound of formula I to be present within insects in order to kill or control the insects. Preferred insecticidally effective amounts are those that are sufficient to kill the insect. It is within the scope of the present invention to cause a compound of formula I to be present within insects by contacting the insects with a derivative of that compound, which derivative is converted within the insect to a compound of formula I. This invention includes the use of such compounds, which can be referred to as pro-insecticides.

Another aspect of the present invention relates to compositions containing an insecticidally effective amount of at least one compound of formula I with at least one insecticidally compatible carrier therefor.

Another aspect of the present invention relates to compositions containing an insecticidally effective amount of at least one compound of formula I, and an effective amount of at least one additional compound, with at least one insecticidally compatible carrier therefor.

Another aspect of the present invention relates to methods of controlling insects by applying an insecticidally effective amount of a composition set forth above to a locus of crops such as, without limitation, cereals, cotton, vegetables, and fruits, or other areas where insects are present or are expected to be present.

The present invention also includes the use of the compounds and compositions set forth herein for control of non-agricultural insect species, for example, dry wood termites and subterranean termites; as well as for use as pharmaceutical agents and compositions thereof. In the field of veterinary medicine, the compounds of the present invention are expected to be effective against certain endo- and ecto-parasites, such as insects and worms, which prey on animals. Examples of such animal parasites include, without limitation, Gastrophilus spp., Stomoxys spp., Trichodectes spp., Rhodnius spp., Ctenocephalides canis, and other species.

As used in this specification and unless otherwise indicated the substituent terms “alkyl” and “alkoxy”, used alone or as part of a larger moiety, includes straight or branched chains of at least one or two carbon atoms, as appropriate to the substituent, and preferably up to 12 carbon atoms, more preferably up to ten carbon atoms, most preferably up to seven carbon atoms. The terms “haloalkyl” and “haloalkoxy” used alone or as part of a larger moiety, includes straight or branched chains of at least one or two carbon atoms, as appropriate to the substituent, and preferably up to 12 carbon atoms, more preferably up to ten carbon atoms, most preferably up to seven carbon atoms, wherein one or more hydrogen atoms have been replaced with halogen atoms, for example, trifluoromethyl or 2,2,2-trifluoroethoxy. The terms “alkenyl” and “alkynyl” used alone or as part of a larger moiety, includes straight or branched chains of at least two carbon atoms containing at least one carbon-carbon double bond or triple bond, and preferably up to 12 carbon atoms, more preferably up to ten carbon atoms, most preferably up to seven carbon atoms. The term “aryl” refers to an aromatic ring structure, including fused rings, having four to ten carbon atoms, for example, phenyl, indanyl, indenyl, naphthyl and 5,6,7,8-tetrahydronaphthyl. The term “heterocyclic” refers to a non-aromatic ring structure, including fused rings in which at least one of the atoms is other than carbon, for example, without limitation, sulfur, oxygen or nitrogen. Examples of heterocyclic rings include, without limitation, pyrrolinyl, pyrrolidinyl, piperidinyl or pyrazolinyl. The term “heteroaryl” refers to an aromatic ring structure, including fused rings, in which at least one of the atoms is other than carbon, for example, without limitation, sulfur, oxygen or nitrogen. Heteroaryl rings include, without limitation, for example, pyridyl, thiophenyl, 2H-benzo[d] 1,3-dioxolenyl or imidazolyl. The term “TEA” refers to triethylamine. The term “halogen” or “halo” refers to fluorine, bromine, iodine, or chlorine. The term “ambient temperature, for example, in reference to a chemical reaction mixture temperature, refers to a temperature in the range of 20° C. to 30° C. The term “GC” refers to gas chromatography. The term “brine” refers to an aqueous saturated sodium chloride solution. The term “insecticidal” or “acaricidal”, “insecticide” or “acaricide” refers to a compound of the present invention, either alone or in admixture with at least one of an additional compound, or with at least one compatible carrier, which causes the destruction or the inhibition of action of insects or acarids.

The compounds of formulae Ia, Ib and Ic can be synthesized by methods that are individually known to one skilled in the art from intermediate compounds readily available in commerce. Compounds of formulae Ia, Ib and Ic, which contain a “formyl” R⁵ substituent, were prepared from the corresponding compound in which the R⁵ substituent was hydrogen. This process is shown in Scheme 1.

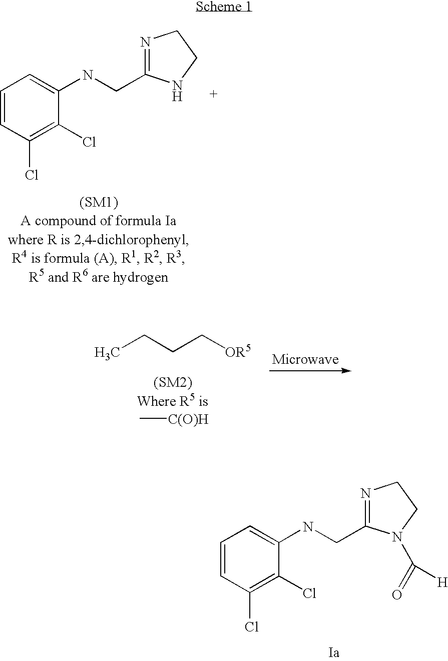

As depicted in Scheme 1, the reaction of an appropriately substituted phenylaminoalkyl-2-imidazoline (SM1) and butyl formate (SM2) using microwave conditions, yielded the appropriately substituted phenylaminomethyl-2-imidazolinylformaldehyde, for example, (2-(((2,3-dichlorophenyl)amino)methyl)-2-imidazolinyl)formaldehyde, a compound of formula Ia described in detail in Example 1 set forth below.

Scheme 2 provides a general method for the preparation of compounds of formulae Ia, Ib and Ic in which the R⁵ substituent is other than hydrogen.

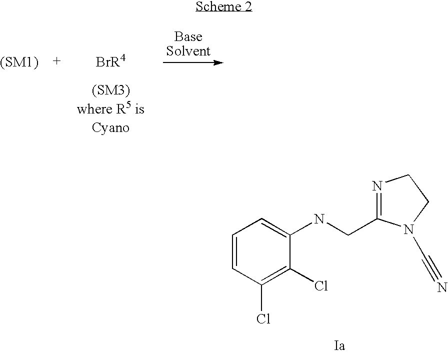

As depicted in Scheme 2, the reaction of an appropriately substituted phenylaminoalkyl-2-imidazoline (SM1) with cyanogen bromide (SM3) under basic conditions, in an appropriate solvent yielded the corresponding phenylaminomethyl-2-imidazolinecarbonitrile, for example, 2-(((2,3-dichlorophenyl)amino)methyl)-2-imidazolinecarbonitrile, a compound of formula Ia described in detail in Example 2 set forth below.

Scheme 3 provides an alternative method for the preparation of compounds of formulae Ia, Ib and Ic in which the R⁵ substituent is other than hydrogen.

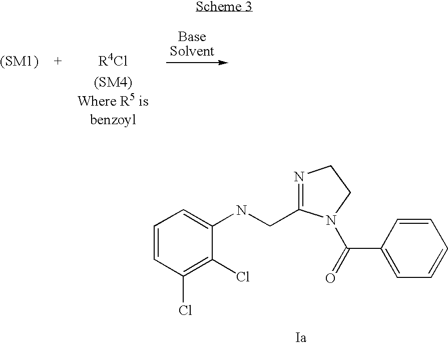

As depicted in Scheme 3, the reaction of a compound of formula I in which the R⁵ substituent is hydrogen, for example (SM1), is reacted with benzoyl chloride under basic conditions in an appropriate solvent to yield the corresponding phenylaminomethyl-2-imidazolinyl phenyl ketone, for example, 2-(((2,3-dichlorophenyl)amino)methyl)(2-imidazolinyl)phenyl ketone, a compound of formula Ia described in detail in Example 3 set forth below.

Scheme 4 provides another method for the preparation of compounds of formula Ia, Ib and Ic in which the R⁵ substituent is other than hydrogen.

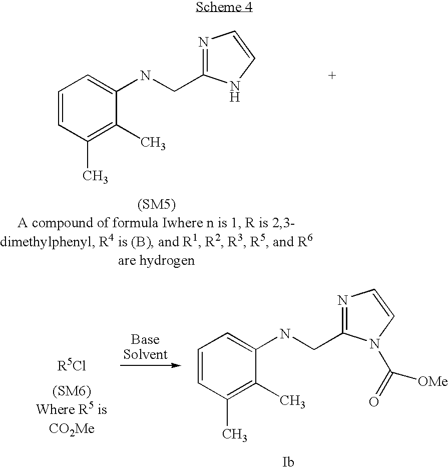

The reaction of an appropriately substituted phenylaminoalkyl-2-imidazole (SM5) with methyl chloroformate (SM6) under basic conditions, in an appropriate solvent yielded a compound of formula Ib in which the R⁵ substituent is an alkyl carboxylate, for example, methyl 2-(((2,3-dimethylphenyl)amino)methyl)imidazole carboxylate, the preparation of which is described in detail in Example 4 set forth below.

Scheme 5 provides a method for the preparation of compounds of formula Ia in which the R² substituent is alkyl.

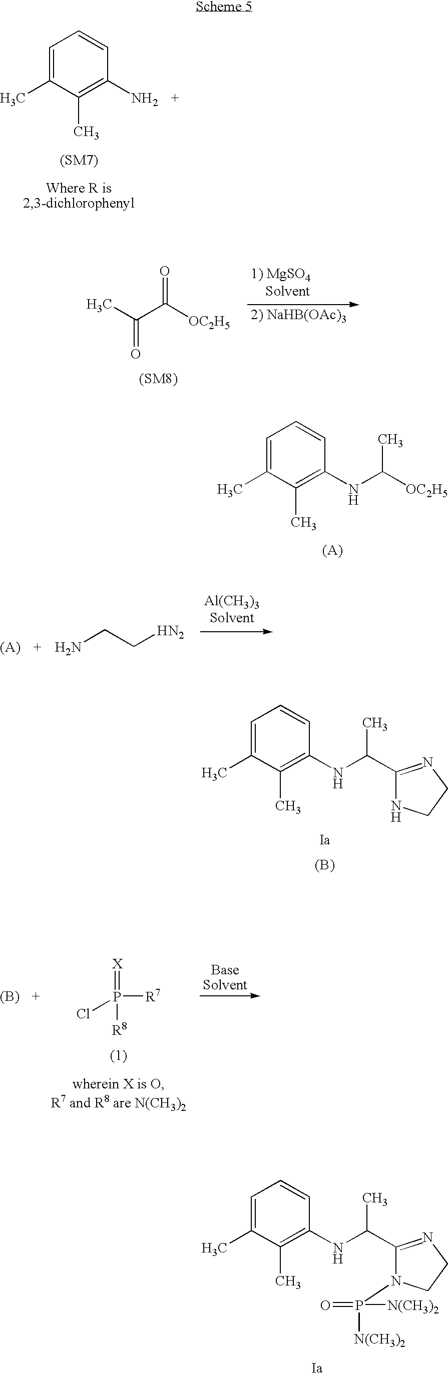

As depicted in Scheme 5, the reaction of an appropriately substituted aniline, for example, 2,3-dimethylanaline, first with ethyl pyruvate in the presence of magnesium sulfate in an appropriate solvent, then with sodium triacetoxyborohydride yielded an appropriately substituted propanoate intermediate (A), for example, ethyl 2-((2,3-dimethylphenyl)amino)propanoate. The reaction of intermediate (A) with ethylenediamine in the presence of trimethylaluminum in an appropriate solvent yielded the appropriately substituted imidazoline amine, for example, (2,3-dimethylphenyl)(2-imidazolin-2-yl)amine, a compound of formula Ia in which the R⁵ substituent is hydrogen and is also an intermediate (B) to other compounds of formula Ia. The reaction of (B) with an appropriately substituted phosphoroamidic chloride, for example, tetramethylphosphoroamidic chloride under basic conditions in an appropriate solvent produced the corresponding phenylaminoethyl-2-imidazolinyl phosphino-1-one, for example, bis(dimethylamino)(2-((2,3-dimethylphenyl)amino)ethyl)(2-imidazolinyl)phosphino-1-one, a compound of formula Ia described in detail in Example 5 set forth below.

Scheme 6 provides a method for the preparation of compounds of formula Ic in which the R⁴ substituent is (C).

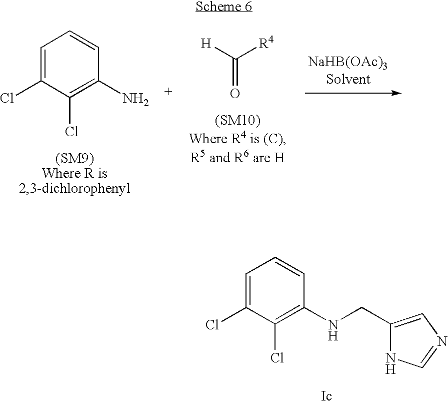

As depicted in scheme 6, the reaction of 2,3-dichloroaniline with an appropriately substituted aldehyde, for example, 4(5)-imidazolecarboxaldehyde, in an appropriate solvent yielded a compound of formula Ic, for example, (2,3-dichlorophenyl)(imidazol-5-ylmethyl)amine. This process is described in detail in Example 6 set forth below.

One skilled in the art will, of course, recognize that the formulation and mode of application of a toxicant may affect the activity of the material in a given application. Thus, for agricultural use the present insecticidal compounds may be formulated as granules of relatively large particle size (for example, 8/16 or 4/8 US Mesh), as water-soluble or water-dispersible granules, as powdery dusts, as wettable powders, as emulsifiable concentrates, as aqueous emulsions, as solutions, or as any of other known types of agriculturally-useful formulations, depending on the desired mode of application. It is to be understood that the amounts specified in this specification are intended to be approximate only, as if the word “about” were placed in front of the amounts specified.

These insecticidal compositions may be applied either as water-diluted sprays, or dusts, or granules to the areas in which suppression of insects is desired. These formulations may contain as little as 0.1%, 0.2% or 0.5% to as much as 95% or more by weight of active ingredient.

Dusts are free flowing admixtures of the active ingredient with finely divided solids such as talc, natural clays, kieselguhr, flours such as walnut shell and cottonseed flours, and other organic and inorganic solids which act as dispersants and carriers for the toxicant; these finely divided solids have an average particle size of less than about 50 microns. A typical dust formulation useful herein is one containing 1.0 part or less of the insecticidal compound and 99.0 parts of talc.

Wettable powders, also useful formulations for insecticides, are in the form of finely divided particles that disperse readily in water or other dispersant. The wettable powder is ultimately applied to the locus where insect control is needed either as a dry dust or as an emulsion in water or other liquid. Typical carriers for wettable powders include Fuller's earth, kaolin clays, silicas, and other highly absorbent, readily wet inorganic diluents. Wettable powders normally are prepared to contain about 5-80% of active ingredient, depending on the absorbency of the carrier, and usually also contain a small amount of a wetting, dispersing or emulsifying agent to facilitate dispersion. For example, a useful wettable powder formulation contains 80.0 parts of the insecticidal compound, 17.9 parts of Palmetto clay, and 1.0 part of sodium lignosulfonate and 0.3 part of sulfonated aliphatic polyester as wetting agents. Additional wetting agent and/or oil will frequently be added to a tank mix to facilitate dispersion on the foliage of the plant.

Other useful formulations for insecticidal applications are emulsifiable concentrates (ECs) which are homogeneous liquid compositions dispersible in water or other dispersant, and may consist entirely of the insecticidal compound and a liquid or solid emulsifying agent, or may also contain a liquid carrier, such as xylene, heavy aromatic naphthas, isophorone, or other non-volatile organic solvents. For insecticidal application these concentrates are dispersed in water or other liquid carrier and normally applied as a spray to the area to be treated. The percentage by weight of the essential active ingredient may vary according to the manner in which the composition is to be applied, but in general comprises 0.5 to 95% of active ingredient by weight of the insecticidal composition.

Flowable formulations are similar to ECs, except that the active ingredient is suspended in a liquid carrier, generally water. Flowables, like ECs, may include a small amount of a surfactant, and will typically contain active ingredients in the range of 0.5 to 95%, frequently from 10 to 50%, by weight of the composition. For application, flowables may be diluted in water or other liquid vehicle, and are normally applied as a spray to the area to be treated.

Typical wetting, dispersing or emulsifying agents used in agricultural formulations include, but are not limited to, the alkyl and alkylaryl sulfonates and sulfates and their sodium salts; alkylaryl polyether alcohols; sulfated higher alcohols; polyethylene oxides; sulfonated animal and vegetable oils; sulfonated petroleum oils; fatty acid esters of polyhydric alcohols and the ethylene oxide addition products of such esters; and the addition product of long-chain mercaptans and ethylene oxide. Many other types of useful surface-active agents are available in commerce. Surface-active agents, when used, normally comprise 1 to 15% by weight of the composition.

Other useful formulations include suspensions of the active ingredient in a relatively non-volatile solvent such as water, corn oil, kerosene, propylene glycol, or other suitable solvents.

Still other useful formulations for insecticidal applications include simple solutions of the active ingredient in a solvent in which it is completely soluble at the desired concentration, such as acetone, alkylated naphthalenes, xylene, or other organic solvents. Granular formulations, wherein the toxicant is carried on relative coarse particles, are of particular utility for aerial distribution or for penetration of cover crop canopy. Pressurized sprays, typically aerosols wherein the active ingredient is dispersed in finely divided form as a result of vaporization of a low-boiling dispersant solvent carrier may also be used. Water-soluble or water-dispersible granules are free flowing, non-dusty, and readily water-soluble or water-miscible. In use by the farmer on the field, the granular formulations, emulsifiable concentrates, flowable concentrates, aqueous emulsions, solutions, etc., may be diluted with water to give a concentration of active ingredient in the range of say 0.1% or 0.2% to 1.5% or 2%.

The active insecticidal and acaricidal compounds of this invention may be formulated and/or applied with at least one additional compound. Such combinations may provide certain advantages, such as, without limitation, exhibiting synergistic effects for greater control of insect pests, reducing rates of application of insecticide thereby minimizing any impact to the environment and to worker safety, controlling a broader spectrum of insect pests, safening of crop plants to phytotoxicity, and improving tolerance by non-pest species, such as mammals and fish.

Additional compounds include, without limitation, other pesticides, plant growth regulators, fertilizers, soil conditioners, or other agricultural chemicals. In applying an active compound of this invention, whether formulated alone or with other agricultural chemicals, an effective amount and concentration of the active compound is of course employed; the amount may vary in the range of, e.g. about 0.001 to about 3 kg/ha, preferably about 0.03 to about 1 kg/ha. For field use, where there are losses of insecticide, higher application rates (e.g., four times the rates mentioned above) may be employed.

When the active insecticidal compounds of the present invention are used in combination with at least one additional compound, e.g., with other pesticides such as herbicides, the herbicides include, without limitation, for example: N-(phosphonomethyl)glycines such as glyphosate; aryloxyalkanoic acids such as 2,4-D, MCPA, and MCPP; ureas such as isoproturon; imidazolinones such as imazapyr, imazamethabenz, imazethapyr, and imazaquin; diphenyl ethers such as acifluorfen, bifenox, and fomasafen; hydroxybenzonitriles such as ioxynil and bromoxynil; sulfonylureas such as chlorimuron, achlorsulfuron, bensulfuron, pyrazosulfuron, thifensulfuron, and triasulfuron; 2-(4-aryloxyphenoxy)alkanoic acids such as fenoxaprop, fluazifop, quizalofop, and diclofop; benzothiadiazinones such as bentazone; 2-chloroacetanilides such as butachlor, metolachlor, acetochlor, and dimethenamide; arenecarboxylic acids such as dicamba; pyridyloxyacetic acids such as fluoroxypyr, aryl triazolinones such as sulfentrazone and carfentrazone-ethyl; isoxazolidinones such as clomazone; and other herbicides.

When the active insecticidal compounds of the present invention are used in combination with at least one additional compound, e.g., with other pesticides such as other insecticides, the other insecticides include, for example: organophosphate insecticides, such as chlorpyrifos, diazinon, dimethoate, malathion, parathion-methyl, and terbufos; pyrethroid insecticides, such as fenvalerate, deltamethrin, fenpropathrin, cyfluthrin, flucythrinate, permethrin, alpha-cypermethrin, beta-cypermethrin, zeta-cypermethrin, bifenthrin, cypermethrin, resolved cyhalothrin, etofenprox, esfenvalerate, tralomethrin, tefluthrin, cycloprothrin, betacyfluthrin, and acrinathrin; carbamate insecticides, such as aldecarb, carbaryl, carbofuran, and methomyl; organochlorine insecticides, such as endosulfan, endrin, heptachlor, and lindane; benzoylurea insecticides, such as diflubenuron, triflumuron, teflubenzuron, chlortluazuron, flucycloxuron, hexaflumuron, flufenoxuron, and lufenuron; and other insecticides, such as amitraz, clofentezine, fenpyroximate, hexythiazox, spinosad, and imidacloprid.

When the active insecticidal compounds of the present invention are used in combination with at least one additional compound, e.g., with other pesticides such as fungicides, the fungicides include, for example: benzimidazole fungicides, such as benomyl, carbendazim, thiabendazole, and thiophanate-methyl; 1,2,4-triazole fungicides, such as epoxyconazole, cyproconazole, flusilazole, flutriafol, propiconazole, tebuconazole, triadimefon, and triadimenol; substituted anilide fungicides, such as metalaxyl, oxadixyl, procymidone, and vinclozolin; organophosphorus fungicides, such as fosetyl, iprobenfos, pyrazophos, edifenphos, and tolclofos-methyl; morpholine fungicides, such as fenpropimorph, tridemorph, and dodemorph; other systemic fungicides, such as fenarimol, imazalil, prochloraz, tricyclazole, and triforine; dithiocarbamate fungicides, such as mancozeb, maneb, propineb, zineb, and ziram; non-systemic fungicides, such as chlorothalonil, dichlofluanid, dithianon, and iprodione, captan, dinocap, dodine, fluazinam, gluazatine, PCNB, pencycuron, quintozene, tricylamide, and validamycin; inorganic fungicides, such as copper and sulphur products, and other fungicides.

When the active insecticidal compounds of the present invention are used in combination with at least one additional compound, e.g., with other pesticides such as nematicides, the nematicides include, for example: carbofuran, carbosulfan, terbufos, aldecarb, ethoprop, fenamphos, oxamyl, isazofos, cadusafos, and other nematicides.

When the active insecticidal compounds of the present invention are used in combination with at least one additional compound, e.g., with other materials such as plant growth regulators, the plant growth regulators include, for example: maleic hydrazide, chlormequat, ethephon, gibberellin, mepiquat, thidiazon, inabenfide, triaphenthenol, paclobutrazol, unaconazol, DCPA, prohexadione, trinexapac-ethyl, and other plant growth regulators.

Soil conditioners are materials which, when added to the soil, promote a variety of benefits for the efficacious growth of plants. Soil conditioners are used to reduce soil compaction, promote and increase effectiveness of drainage, improve soil permeability, promote optimum plant nutrient content in the soil, and promote better pesticide and fertilizer incorporation. When the active insecticidal compounds of the present invention are used in combination with at least one additional compound, e.g., with other materials such as soil conditioners, the soil conditioners include organic matter, such as humus, which promotes retention of cation plant nutrients in the soil; mixtures of cation nutrients, such as calcium, magnesium, potash, sodium, and hydrogen complexes; or microorganism compositions which promote conditions in the soil favorable to plant growth. Such microorganism compositions include, for example, bacillus, pseudomonas, azotobacter, azospirillum, rHizobium, and soil-borne cyanobacteria.

Fertilizers are plant food supplements, which commonly contain nitrogen, phosphorus, and potassium. When the active insecticidal compounds of the present invention are used in combination with at least one additional compound, e.g., with other materials such as fertilizers, the fertilizers include nitrogen fertilizers, such as ammonium sulfate, ammonium nitrate, and bone meal; phosphate fertilizers, such as superphosphate, triple superphosphate, ammonium sulfate, and diammonium sulfate; and potassium fertilizers, such as muriate of potash, potassium sulfate, and potassium nitrate, and other fertilizers.

The following examples further illustrate the present invention, but, of course, should not be construed as in any way limiting its scope. The examples are organized to present protocols for the synthesis of the compounds of formula I of the present invention, set forth a list of such synthesized species, and set forth certain biological data indicating the efficacy of such compounds.

The compounds of formula I can be synthesized by methods that are individually known to one skilled in the art from intermediate compounds readily available in commerce.

### Example 1

### This Example Illustrates One Protocol for the Preparation of (2-(((2,3-dichlorophenyl)amino)methyl)-2-imidazolinyl)formaldehyde (Compound 11)

Into a microwave reaction vial, equipped with a stir bar, was placed 0.1 gram (0.0004 mole) of 2-(((2,3-dichlorophenyl)amino)methyl)-2-imidazoline (known compound, U.S. Pat. No. 4,254,133) and 0.45 gram (0.0044 mole) of butyl formate. The reaction vial was sealed and placed in a chemical reaction microwave apparatus with the following parameters: stirring on, 250 W power, 180° C. maximum temperature, 2 minutes temperature ramp time, and hold 5 minutes at 180° C. The reaction mixture was allowed to cool and stand at ambient temperature for about 18 hours. The reaction mixture was dissolved in a small amount of dichloromethane and the solution was purified by column chromatography on silica gel, eluting with a mixture of methanol and dichloromethane (5:95). The appropriate fractions were combined and concentrated under reduced pressure to yield 0.04 gram of the title compound as a solid. The NMR spectrum was consistent with the proposed structure.

### Example 2

### This Example Illustrates One Protocol for the Preparation of 2-(((2,3-dichlorophenyl)amino)methyl)-2-imidazolinecarbonitrile (Compound 17)

Under a dry nitrogen atmosphere, 1.7 mL of a solution of TEA in dichloromethane (1 mL, 0.0072 mole, TEA dissolved in 30 mL of dichloromethane) was added to a cold (0° C.), stirred solution of 0.1 gram (0.0004 mole) of 2-(((2,3-dichlorophenyl)amino)methyl)-2-imidazoline in 25 mL of dichloromethane. After five minutes, 4.1 mL of a 0.0001 molar solution of cyanogen bromide in methylene chloride, prepared by diluting 1.0 mL of a 3.0 molar solution of cyanogen bromide in dichloromethane with 30 mL of dichloromethane, was added to the reaction mixture. The reaction mixture was allowed to warm to ambient temperature where it stirred for six hours. The reaction mixture was diluted with an aqueous saturated ammonium chloride solution and extracted with two portions of dichloromethane. The extracts were combined, washed with an aqueous saturated ammonium chloride solution, dried with sodium sulfate and filtered. The filtrate was purified by column chromatography on silica gel, eluting with mixtures of methanol in dichloromethane (1:99-2:98). The appropriate fractions were combined and concentrated under reduced pressure to yield 0.077 gram of the title compound as a solid. The NMR spectrum was consistent with the proposed structure.

### Example 3

### This Example Illustrates One Protocol for the Preparation of 2-(((2,3-dichlorophenyl)amino)methyl)(2-imidazolinyl)phenyl ketone (Compound 20)

Benzoyl chloride (0.112 gram, 0.0008 mole) was added to a cold (0° C.), stirred solution of 0.2 gram (0.0008 mole) of 2-(((2,3-dichlorophenyl)amino)methyl)-2-imidazoline and 0.22 gram (0.0016 mole) of diisopropylethylamine in 25 mL of dichloromethane. The reaction mixture was allowed to warm to ambient temperature where it stirred for three hours. The reaction mixture was purified by column chromatography on silica gel, eluting with a mixture of methanol in dichloromethane (1:99). The appropriate fractions were combined and concentrated under reduced pressure to yield 0.022 gram of the title compound as a solid. The NMR spectrum was consistent with the proposed structure.

### Example 4

### This Example Illustrates One Protocol for the Preparation of methyl 2-(((2,3-dimethylphenyl)amino)methyl)imidazole carboxylate (Compound 79)

In a manner analogous to Example 3, the reaction of 0.5 gram (0.00055 mole) of methyl chloroformate with 0.1 gram (0.0005 mole) of (2,3-dimethylphenyl)(imidazole-2-ylmethyl)amine (known compound, International Publication WO 2004/014898 A1) and 0.12 gram (0.001 mole) of diisopropylethylamine in 25 mL of dichloromethane yielded 0.5 gram of the title compound as a solid. The NMR spectrum was consistent with the proposed structure.

### Example 5

### This Example Illustrates One Protocol for the Preparation of (2,3-dimethylphenyl)(2-imidazolin-2-yl)amine (Compound 57) and bis(dimethylamino)(2-((2,3-dimethylphenyl)amino)ethyl)(2-imidazolinyl)phosphino-1-one (Compound 58)

### Step A Synthesis of ethyl 2-((2,3-dimethylphenyl)amino)propanoate as an Intermediate

Under a dry nitrogen atmosphere, a mixture of 15.0 grams (0.124 mole) of 2,3-dimethylaniline, 21.6 grams (0.186 mole) of ethyl pyruvate and 44.7 grams (0.372 mole) of magnesium sulfate in 300 mL of dichloromethane was stirred at ambient temperature for about 18 hours. Analysis of an aliquot of the reaction mixture, diluted with dichloromethane, by TLC and GC indicated the reaction was incomplete. Additional ethyl pyruvate (5.2 grams, 0.05 mole) was added and the reaction mixture was stirred at ambient temperature for 24 hours. Analysis of an aliquot of the reaction mixture by GC indicated that about 10% of the 2,3-dimethylaniline remained unreacted. Five grams of powdered, 4 angstrom, molecular sieves was added and the mixture stirred at 35° C. for three days. The reaction mixture was cooled to about 26° C. and an aliquot of the mixture was analyzed by GC which indicated that about 5% of the aniline remained unreacted. Sodium triacetoxyborohydride (26.3 grams, 0.124 mole) was added during a 30 minute period while maintaining a reaction temperature of about 26° C. using an ice bath. After complete addition, the reaction mixture stirred at 26° C. for two hours. Analysis of the mixture by GC indicated incomplete reaction and 13.0 grams (0.06 mole) of sodium triacetoxyborohydride was added. The reaction mixture was stirred at 26° C. for about 24 hours at which time GC analysis indicated incomplete reaction and 13.0 grams of sodium triacetoxyborohydride was added. The reaction mixture stirred at 26° C. for 24 hours, was analyzed by GC whereupon an additional 2.5 grams of sodium triacetoxyborohydride was added and the mixture was allowed to stir at 26° C. for 24 more hours. The reaction mixture was added to a separatory funnel and was diluted with 500 mL of dichloromethane, 200 mL of brine and 200 mL of shaved ice. Solid sodium bicarbonate was added to the aqueous phase to adjust the pH to between 6 and 7. The mixture was shaken and the organic phase was separated from the aqueous phase. The organic phase was washed in succession with three portions of an aqueous saturated sodium bicarbonate solution and two portions of brine. The washed organic phase was dried with sodium sulfate, filtered and the filtrate concentrated under reduced pressure leaving an oily residue. The oily residue was dissolved in 700 mL of hexanes and extracted with two portions of 1N hydrochloric acid. The hexanes phase was set aside for later use. The acidic aqueous extracts were combined, the pH adjusted to between 6 and 7 with solid sodium bicarbonate and extracted with three portions of hexanes. The extracts were combined with the hexanes phase set aside above, dried with sodium sulfate and filtered. The filtrate was concentrated under reduced pressure leaving an oil residue. The residue was purified by column chromatography on silica gel, eluting with mixtures of petroleum ether and ethyl acetate. The appropriate fractions were combined and concentrated under reduced pressure to yield 16.1 grams of ethyl 2-[(2,3-dimethylphenyl)amino]propanoate as an oil that slowly solidified. The NMR spectrum was consistent with the proposed structure.

### Step B Synthesis of (2,3-dimethylphenyl)(2-imidazolin-2-yl)amine (Compound 57)

Under a dry nitrogen atmosphere, 2.25 mL of a 2.0 molar solution of trimethylaluminum in toluene (0.0045 mole) was added to 60 mL of toluene. The solution was stirred, cooled to 0° C. and 0.27 gram (0.0045 mole) of ethylenediamine was added. After stirring for 10 minutes the reaction mixture was allowed to warm to ambient temperature and 1.0 gram (0.0045 mole) of ethyl 2-[(2,3-dimethylphenyl)amino]propanoate dissolved in 5 mL of toluene was added. The reaction mixture was heated at reflux for about 18 hours, and then cooled to ambient temperature. Analysis of an aliquot of the reaction mixture by GC indicated incomplete reaction. Additional ethylenediamine (0.54 gram, 0.009 mole) and trimethylaluminum solution (9.0 mL, 0.009 mole) was added and the reaction mixture was heated at reflux for about 24 hours. The reaction mixture was cooled to ambient temperature, diluted with brine and extracted with ethyl acetate. The extract was washed with two portions of brine, dried with sodium sulfate and was filtered. The filtrate was concentrated under reduced pressure leaving a residue. The residue was purified by column chromatography on basic alumina; grade II, 3% water, eluted with mixtures of methanol and dichloromethane. The appropriate fractions were combined and concentrated under reduced pressure to yield 0.98 gram of (2,3-dimethylphenyl)(2-imidazolin-2-yl)amine, Compound 57, as a solid. The NMR spectrum was consistent with the proposed structure.

### Step C Synthesis of bis(dimethylamino)(2-(((2,3-dimethylphenyl)amino)ethyl)(2-imidazolinyl)phosphino-1-one (Compound 58)

A mixture of 0.3 gram (0.0014 mole) of (2,3-dimethylphenyl)(2-imidazolin-2-yl)amine, 0.25 gram (0.0014 mole) of N,N-diisopropylethylamine and 0.19 gram (0.0014 mole) of tetramethylphosphorodiamidic chloride in 10 mL of dichloromethane was stirred at ambient temperature for about 18 hours. The reaction mixture was concentrated under reduced pressure leaving a residue. The residue was purified by column chromatography on silica gel, eluting with dichloromethane and methanol (9:1). The appropriate fractions were combined and concentrated under reduced pressure to yield 0.3 gram of bis(dimethylamino)(2-(((2,3-dimethylphenyl)amino)ethyl)(2-imidazolinyl)phosphino-1-one, Compound 58, as an oil. The NMR spectrum was consistent with the proposed structure.

### Example 6

This Example Illustrates One Protocol for the Preparation of (2,3-dichlorophenyl)(imidazol-5-ylmethyl)amine (Compound 132)

A mixture of 1.0 gram (0.0061 mole) of 2,3-dichloroaniline, 1.07 gram (0.0061 mole) of 4(5)-imidazolecarboxaldehyde and 1.8 gram (0.0085 mole) of sodium triacetoxyborohydride in 30 mL of dichloromethane was stirred at ambient temperature for about 18 hours. The reaction mixture was diluted with 50 mL of 1N aqueous sodium hydroxide, then extracted with three 100 mL portions of ethyl acetate. The extracts were combined, dried with sodium sulfate and filtered. The filtrate was concentrated under reduced pressure to leave a residue. The residue was dissolved in 10 mL of dichloromethane and the solution was purified by column chromatography on silica gel, eluting with methylene chloride and methanol (95:5). The appropriate fractions were combined and concentrated under reduced pressure to yield 0.77 gram of (2,3-dichlorophenyl)(imidazol-5-ylmethyl)amine, Compound 132, as a solid. The NMR spectrum was consistent with the proposed structure.

The following table sets forth some additional examples of compounds of formula I useful in the present invention:

TABLE 1
Insecticidal Substituted Aminoalkyl Heteroaryl And Heterocyclyl Derivatives

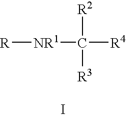

R¹ and R³ are hydrogen, R⁴ is

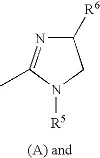

R⁶ is hydrogen unless otherwise noted

| Cmpd No | R | R² | R⁵ |
|---|---|---|---|
| 1 Hydroiodide salt | 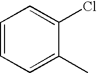 | H | H |
| 2 | 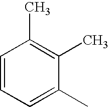 | H | H |
| 3 | 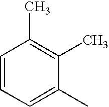 | H | 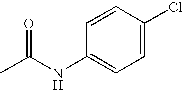 |
| 4 | 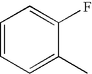 | H | 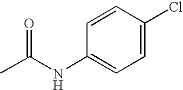 |
| 5 | 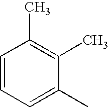 | H | 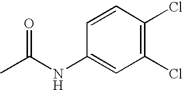 |
| 6 Hydrochloride salt | 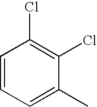 | H | H |
| 7 Hydrochloride salt | 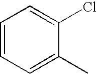 | H | H |
| 8 | 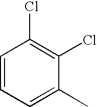 | H | H |
| 9 | 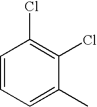 | H | —COC(CH₃)₃ |
| 10 | 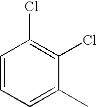 | H | —COCH(CH₃)₂C₂H₅ |
| 11 | 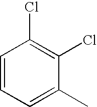 | H | —COH |
| 12 | 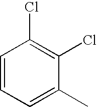 | H | —COCH(CH₃)₂ |
| 13 | 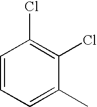 | H | —COCH₂C(CH₃)₃ |
| 14 | 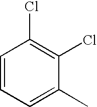 | H | —COC₃H₇ |
| 15 | 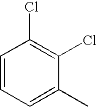 | H | —COC₄H₉ |
| 16 | 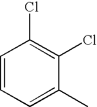 | H | —CH₂OC₂H₅ |
| 17 | 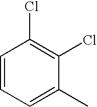 | H | —CN |
| 18 | 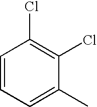 | H | 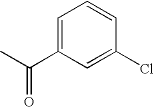 |
| 19 | 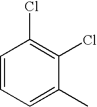 | H | 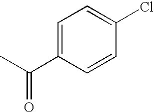 |
| 20 | 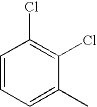 | H | 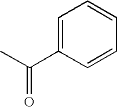 |
| 21 | 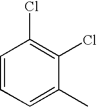 | H | 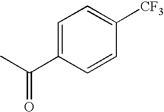 |
| 22 | 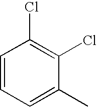 | H | 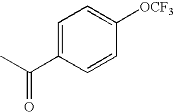 |
| 23 | 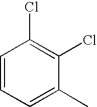 | H | 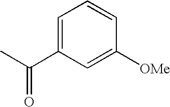 |
| 24 | 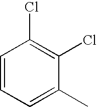 | H | 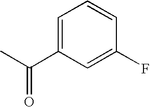 |
| 25 | 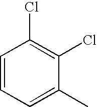 | H | 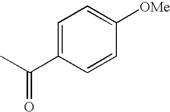 |
| 26 | 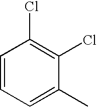 | H | —PS(OC₂H₅)₂ |
| 27 | 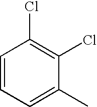 | H | —CH₂OCH₃ |
| 28 | 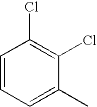 | H | —PO(N(CH₃)₂)₂ |
| 29 | 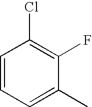 | H | H |
| 30 | 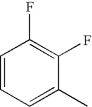 | H | H |
| 31 p-Toluene sulfonate salt | 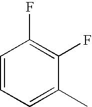 | H | H |
| 32 | 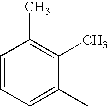 | H | H |
| 33 | 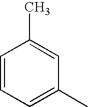 | H | H |
| *34 | 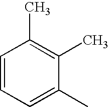 | H | H |
| 35 | 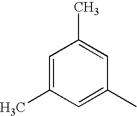 | H | H |
| 36 | 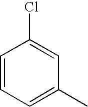 | H | H |
| 37 | 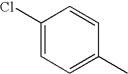 | H | H |
| 38 | 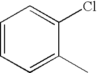 | H | H |
| 39 | 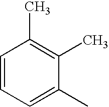 | H | —CO₂CH₃ |
| 40 | 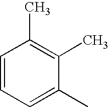 | H | —COH |
| 41 | 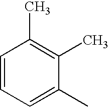 | H | —PS(OC₂H₅)₂ |
| 42 | 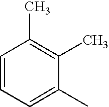 | H | —PO(OCH₃)₂ |
| 43 | 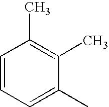 | H | —PO(N(CH₃)₂)₂ |
| 44 | 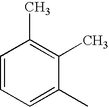 | H | —CH₂OCH₃ |
| 45 | 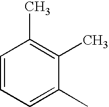 | H | —CH₂OC₂H₅ |
| 46 | 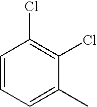 | H | —PO(OC₂H₅)₂ |
| 47 | 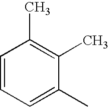 | H | —COC(CH₃)₃ |
| 48 | 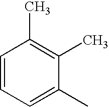 | H | —PO(OC₂H₅)₂ |
| 49 | 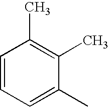 | H | —SO₂CF₃ |
| 50 | 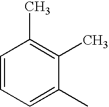 | H | —PS(OCH₃)₂ |
| 51 | 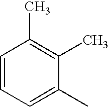 | H | —COCH₂CO₂C₂H₅ |
| 52 | 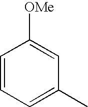 | H | H |
| 53 | 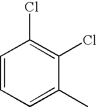 | H | —CH═NC₂H₅ |
| 54 | 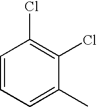 | H | —CH═NOC₂H₅ |
| 55 | 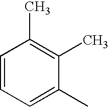 | H | —CH═NC₂H₅ |
| 56 | 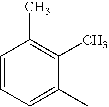 | H | —CH═NOC₂H₅ |
| 57 | 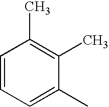 | —CH₃ | H |
| 58 | 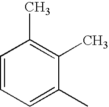 | —CH₃ | —PO(N(CH₃)₂)₂ |
| 59 | 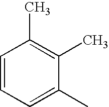 | —CH₃ | —PO(OC₂H₅)₂ |

*Compound 34, R⁶ is —CH₃

Formula I where R² and R³ are hydrogen, R⁴ is

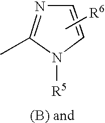

R⁶ is hydrogen

| Cmpd No | R | R¹ | R⁵ |
|---|---|---|---|
| 60 | 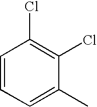 | H | H |
| 61 | 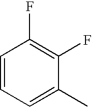 | H | H |
| 62 | 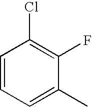 | H | H |
| 63 | 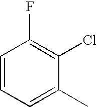 | H | H |
| 64 | 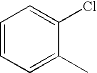 | H | H |
| 65 | 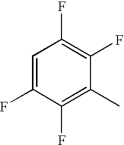 | H | H |
| 66 | 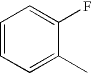 | H | H |
| 67 | 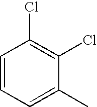 | H | —SO₂N(CH₃)₂ |
| 68 | 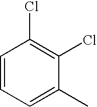 | H | —COCH₃ |
| 69 | 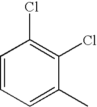 | H | —PO(N(CH₃)₂)₂ |
| 70 | 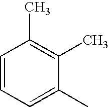 | H | —SO₂N(CH₃)₂ |
| 71 | 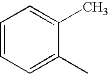 | H | —SO₂N(CH₃)₂ |
| 72 | 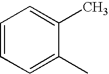 | H | H |
| 73 | 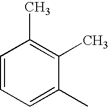 | H | H |
| 74 | 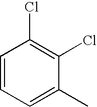 | H | —CO₂C₂H₅ |
| 75 | 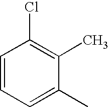 | H | —SO₂N(CH₃)₂ |
| 76 | 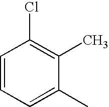 | H | H |
| 77 | 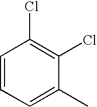 | H | —CSN(CH₃)₂ |
| 78 | 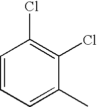 | H | —CON(CH₃)₂ |
| 79 | 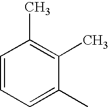 | H | —CO₂CH₃ |
| 80 | 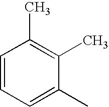 | H | —COCH₃ |
| 81 | 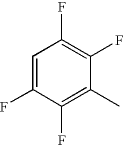 | H | —SO₂N(CH₃)₂ |
| 82 | 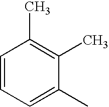 | H | —CO₂C₂H₅ |
| 83 | 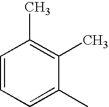 | H | —PO(OC₂H₅)₂ |
| 84 | 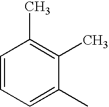 | H | —CON(CH₃)₂ |
| 85 | 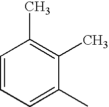 | H | —CO₂CH(CH₃)₂ |
| 86 | 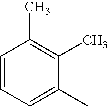 | H | —PO(N(CH₃)₂)₂ |
| 87 | 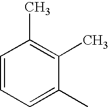 | H | —COC₂H₅ |
| 88 | 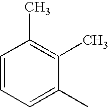 | H | —COCH(CH₃)₂ |
| 89 | 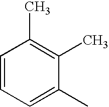 | H | —CONHC₂H₅ |
| 90 | 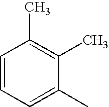 | H | —CONHCH₃ |
| 91 | 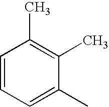 | H | —SO₂CH₃ |
| 92 | 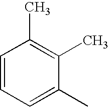 | H | —CO₂C₃H₇ |
| 93 | 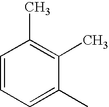 | H | —CO₂CH₂CH(CH₃)₂ |
| 94 | 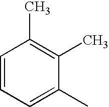 | H | —CO₂C₄H₉ |
| 95 | 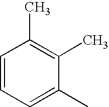 | H | —CO₂CH₂C≡CH |
| 96 | 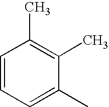 | H | —CH₂OCH₃ |
| 97 | 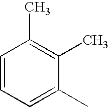 | H | —COCH₂C(CH₃)₃ |
| 98 | 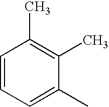 | H | 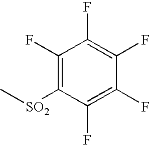 |
| 99 | 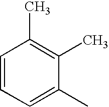 | H | —COC(CH₃)₂C₂H₅ |
| 100 | 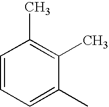 | H | 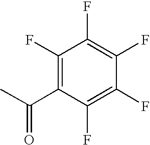 |
| 101 | 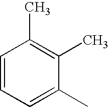 | H | —COCH₂CH(CH₃)₂ |
| 102 | 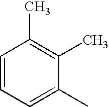 | H | —COC₄H₉ |
| 103 | 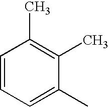 | H | —SO₂CF₃ |
| 104 | 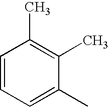 | H | —CH₂OC₂H₅ |
| 105 | 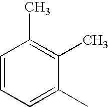 | H | —CH₃ |
| 106 | 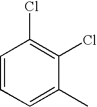 | H | —CH═NC₂H₅ |
| 107 | 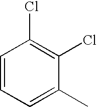 | H | —CH═NOC₂H₅ |
| 108 | 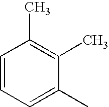 | H | —CH═NC₂H₅ |
| 109 | 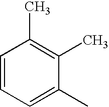 | H | —CH═NOC₂H₅ |
| 110 | 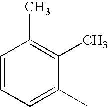 | —CO₂CH(CH₃)₂ | —CO₂CH(CH₃)₂ |
| 111 | 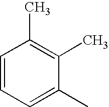 | —CSNHCH₃ | H |
| 112 | 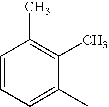 | —COH | H |
| 113 | 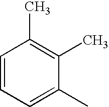 | H | —CO₂CH(CH₃)CH₂CO₂CH₂C₆H₅ |
| 114 | 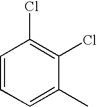 | H | —CSNH₂ |
| 115 | 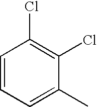 | H | —CSNHCH₃ |
| 116 | 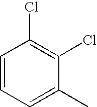 | H | —CSNHC₂H₅ |
| 117 | 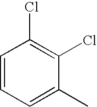 | H | —CSNHC₂H₄OCH₃ |
| 118 | 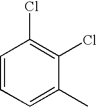 | H | —CSNHCH₂CN |
| 119 | 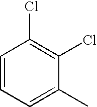 | H | —CSNHCH(CH₃)₂ |
| 120 | 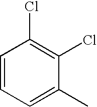 | H | —CSNHCH₂CO₂CH₃ |
| 121 | 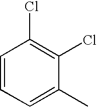 | H | —CSNHC₂H₄CO₂CH₃ |
| 122 | 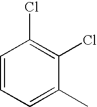 | H | 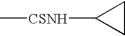 |
| 123 | 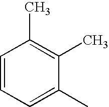 | H | —CSNH₂ |
| 124 | 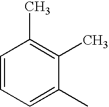 | H | —CSNHCH₃ |
| 125 | 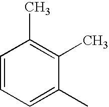 | H | —CSNHC₂H₅ |
| 126 | 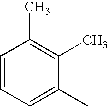 | H | —CSNHC₂H₄OCH₃ |
| 127 | 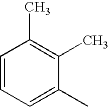 | H | —CSNHCH₂CN |
| 128 | 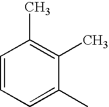 | H | —CSNHCH(CH₃)₂ |
| 129 | 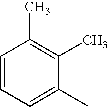 | H | —CSNHCH₂CO₂CH₃ |
| 130 | 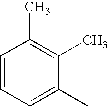 | H | —CSNHC₂H₄CO₂CH₃ |
| 131 | 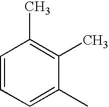 | H | 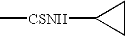 |

Formula I where R¹, R² and R³ are hydrogen, R⁴ is

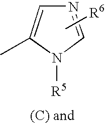

R⁶ is hydrogen

| Cmpd No | R | R⁵ |
|---|---|---|
| 132 | 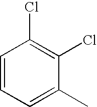 | H |
| 133 | 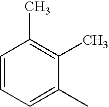 | H |
| 134 | 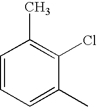 | H |
| 135 | 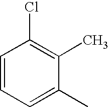 | H |
| 136 | 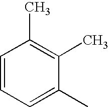 | —COCH₃ |
| 137 | 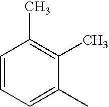 | —SO₂N(CH₃)₂ |
| 138 | 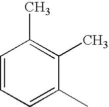 | —PO(OC₂H₅)₂ |
| 139 | 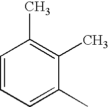 | —PS(OC₂H₅)₂ |
| 140 | 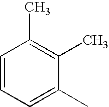 | —CO₂CH₃ |
| 141 | 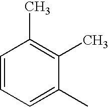 | —CHO |
| 142 | 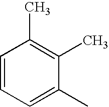 | —CONHCH₃ |
| 143 | 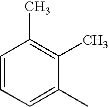 | —CSNHCH₃ |
| 144 | 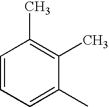 | —CH═NC₂H₅ |
| 145 | 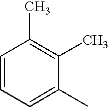 | —CH═NOC₂H₅ |
| 146 | 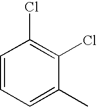 | —COCH₃ |
| 147 | 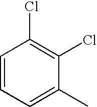 | —SO₂N(CH₃)₂ |
| 148 | 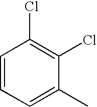 | —PO(OC₂H₅)₂ |
| 149 | 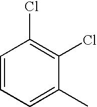 | —PS(OC₂H₅)₂ |
| 150 | 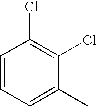 | —CO₂CH₃ |
| 151 | 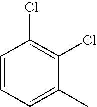 | —CHO |
| 152 | 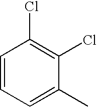 | —CONHCH₃ |
| 153 | 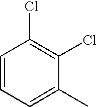 | —CSNHCH₃ |
| 154 | 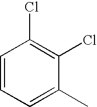 | —CH═NC₂H₅ |
| 155 | 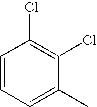 | —CH═NOC₂H₅ |

Formula I where R¹, R² and R³ are hydrogen, R⁴ is

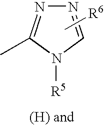

R⁶ is hydrogen

| Cmpd No | R | R⁵ |
|---|---|---|
| 156 | 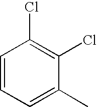 | H |
| 157 | 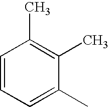 | H |
| 158 | 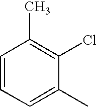 | H |
| 159 | 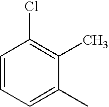 | H |
| 160 | 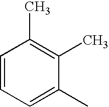 | —COCH₃ |
| 161 | 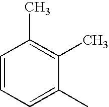 | —SO₂N(CH₃)₂ |
| 162 | 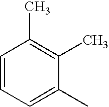 | —PO(OC₂H₅)₂ |
| 163 | 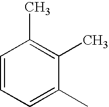 | —PS(OC₂H₅)₂ |
| 164 | 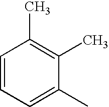 | —CO₂CH₃ |
| 165 | 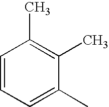 | —CHO |
| 166 | 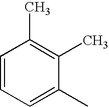 | —CONHCH₃ |
| 167 | 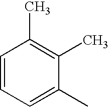 | —CSNHCH₃ |
| 168 | 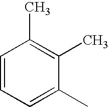 | —CH═NC₂H₅ |
| 169 | 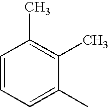 | —CH═NOC₂H₅ |
| 170 | 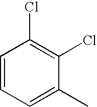 | —COCH₃ |
| 171 | 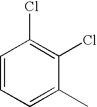 | —SO₂N(CH₃)₂ |
| 172 | 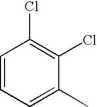 | —PO(OC₂H₅)₂ |
| 173 | 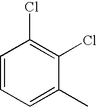 | —PS(OC₂H₅)₂ |
| 174 | 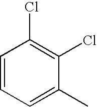 | —CO₂CH₃ |
| 175 | 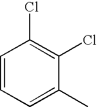 | —CHO |
| 176 | 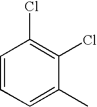 | —CONHCH₃ |
| 177 | 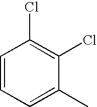 | —CSNHCH₃ |
| 178 | 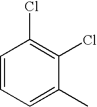 | —CH═NC₂H₅ |
| 179 | 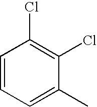 | —CH═NOC₂H₅ |

Formula I where R¹, R² and R³ are hydrogen, R⁴ is

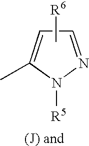

R⁶ is hydrogen

| Cmpd No | R | R⁵ |
|---|---|---|
| 180 | 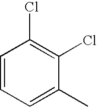 | H |
| 181 | 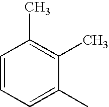 | H |
| 182 | 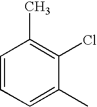 | H |
| 183 | 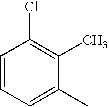 | H |
| 184 | 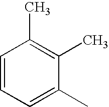 | —COCH₃ |
| 185 | 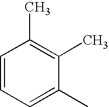 | —SO₂N(CH₃)₂ |
| 186 | 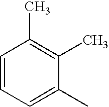 | —PO(OC₂H₅)₂ |
| 187 | 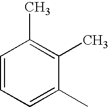 | —PS(OC₂H₅)₂ |
| 188 | 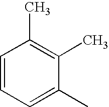 | —CO₂CH₃ |
| 189 | 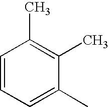 | —CHO |
| 190 | 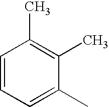 | —CONHCH₃ |
| 191 | 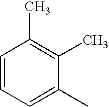 | —CSNHCH₃ |
| 192 | 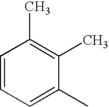 | —CH═NC₂H₅ |
| 193 | 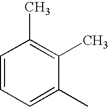 | —CH═NOC₂H₅ |
| 194 | 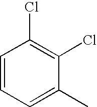 | —COCH₃ |
| 195 | 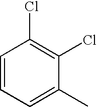 | —SO₂N(CH₃)₂ |
| 196 | 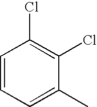 | —PO(OC₂H₅)₂ |
| 197 | 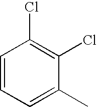 | —PS(OC₂H₅)₂ |
| 198 | 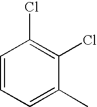 | —CO₂CH₃ |
| 200 | 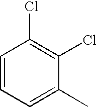 | —CHO |
| 201 | 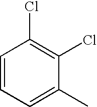 | —CONHCH₃ |
| 202 | 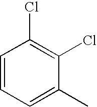 | —CSNHCH₃ |
| 203 | 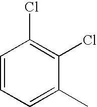 | —CH═NC₂H₅ |
| 204 | 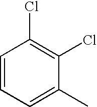 | —CH═NOC₂H₅ |

Formula I where R¹, R² and R³ are hydrogen, R⁴ is

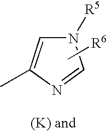

R⁶ is hydrogen

| Cmpd No | R | R⁵ |
|---|---|---|
| 205 | 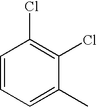 | H |
| 206 | 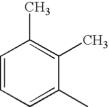 | H |
| 207 | 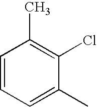 | H |
| 208 | 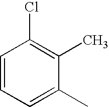 | H |
| 209 | 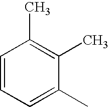 | —COCH₃ |
| 210 | 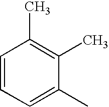 | —SO₂N(CH₃)₂ |
| 211 | 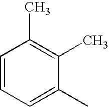 | —PO(OC₂H₅)₂ |
| 212 | 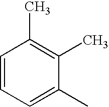 | —PS(OC₂H₅)₂ |
| 213 | 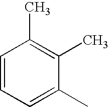 | —CO₂CH₃ |
| 214 | 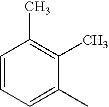 | —CHO |
| 215 | 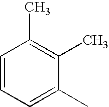 | —CONHCH₃ |
| 216 | 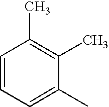 | —CSNHCH₃ |
| 217 | 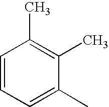 | —CH═NC₂H₅ |
| 218 | 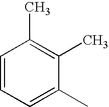 | —CH═NOC₂H₅ |
| 219 | 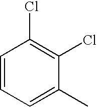 | —COCH₃ |
| 210 | 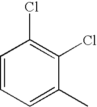 | —SO₂N(CH₃)₂ |
| 211 | 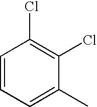 | —PO(OC₂H₅)₂ |
| 212 | 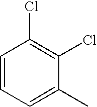 | —PS(OC₂H₅)₂ |
| 213 | 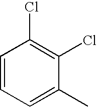 | —CO₂CH₃ |
| 214 | 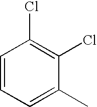 | —CHO |
| 215 | 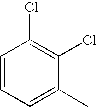 | —CONHCH₃ |
| 216 | 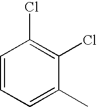 | CSNHCH₃ |
| 217 | 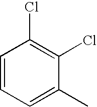 | —CH═NC₂H₅ |
| 218 | 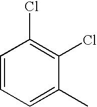 | —CH═NOC₂H₅ |

The following table sets forth physical characterizing data for certain compounds of formula I of the present invention:

TABLE 2
Insecticidal Aminoalkyl Heteroaryl And Heterocyclyl
Derivatives Compound Characterization

| | | Melting Point (° C.) of Solids |
|---|---|---|
| Cmpd No | Molecular Formula | Or Physical State |
| 1 | C₁₀H₁₂ClN₃—HI | — |
| 2 | C₁₂H₁₇N₃—HCl | 182-185 |
| 3 | C₁₉H₂₁ClN₄O | — |
| 4 | C₁₇H₁₆ClFN₄O | — |
| 5 | C₁₉H₂₀Cl₂N₄O | — |
| 6 | C₁₀H₁₁Cl₂N₃—HCl | SOLID |
| 7 | C₁₀H₁₂ClN₃—HCl | SOLID |
| 8 | C₁₀H₁₁Cl₂N₃ | 230 |
| 9 | C₁₅H₁₉Cl₂N₃O | 154-155 |
| 10 | C₁₆H₂₁Cl₂N₃O | 153-154 |
| 11 | C₁₁H₁₁Cl₂N₃O | SOLID |
| 12 | C₁₄H₁₇Cl₂N₃O | 138-139 |
| 13 | C₁₆H₂₁Cl₂N₃O | 175-176 |
| 14 | C₁₄H₁₇Cl₂N₃O | 192-193 |
| 15 | C₁₅H₁₉Cl₂N₃O | 181-182 |
| 16 | C₁₃H₁₇Cl₂N₃O | 81-82 |
| 17 | C₁₁H₁₀Cl₂N₄ | 150-152 |
| 18 | C₁₇H₁₄Cl₃N₃O | 181-182 |
| 19 | C₁₇H₁₄Cl₃N₃O | 154-155 |
| 20 | C₁₇H₁₅Cl₂N₃O | 156-157 |
| 21 | C₁₈H₁₄Cl₂F₃N₃O | 150-151 |
| 22 | C₁₈H₁₄Cl₂F₃N₃O₂ | SOLID |
| 23 | C₁₈H₁₇Cl₂N₃O₂ | 150-151 |
| 24 | C₁₇H₁₄Cl₂FN₃O | 157-158 |
| 25 | C₁₈H₁₇Cl₂N₃O₂ | 127-128 |
| 26 | C₁₄H₂₀Cl₂N₃O₂PS | 66-68 |
| 27 | C₁₂H₁₅Cl₂N₃O | 109-110 |
| 28 | C₁₄H₂₂Cl₂N₅OP | 151-153 |
| 29 | C₁₀H₁₁ClFN₃ | 127-128 |
| 30 | C₁₀H₁₁F₂N₃ | 129-130 |
| 31 | C₁₀H₁₂F₂N₃—C₇H₇O₃S | 156-157 |
| 32 | C₁₂H₁₇N₃ | 71-72 |
| 33 | C₁₁H₁₅N₃ | OIL |
| 34 | C₁₃H₁₉N₃ | OIL |
| 35 | C₁₂H₁₇N₃ | OIL |
| 36 | C₁₀H₁₂ClN₃ | 89-90 |
| 37 | C₁₀H₁₂ClN₃ | 148-149 |
| 38 | C₁₀H₁₂ClN₃ | 115-116 |
| 39 | C₁₄H₁₉N₃O₂ | 137-139 |
| 40 | C₁₃H₁₇N₃O | 174-175 |
| 41 | C₁₆H₂₆N₃O₂PS | OIL |
| 42 | C₁₄H₂₂N₃O₃P | OIL |
| 43 | C₁₆H₂₈N₅OP | OIL |
| 44 | C₁₄H₂₁N₃O | OIL |
| 45 | C₁₅H₂₃N₃O | OIL |
| 46 | C₁₄H₂₀Cl₂N₃O₃P | OIL |
| 47 | C₁₇H₂₅N₃O | 138-139 |
| 48 | C₁₆H₂₆N₃O₃P | OIL |
| 49 | C₁₃H₁₆F₃N₃O₂S | 117-118 |
| 50 | C₁₄H₂₂N₃O₂PS | OIL |
| 51 | C₁₇H₂₃N₃O₃ | 135-136 |
| 52 | C₁₁H₁₅N₃O | OIL |
| 57 | C₁₃H₁₉N₃ | 97-99 |
| 58 | C₁₇H₃₀N₅OP | OIL |
| 59 | C₁₇H₂₈N₃O₃P | 65-66 |
| 60 | C₁₀H₉Cl₂N₃ | SOLID |
| 61 | C₁₀H₉F₂N₃ | 125-126 |
| 62 | C₁₀H₉ClFN₃ | 119-120 |
| 63 | C₁₀H₉ClFN₃ | 131-133 |
| 64 | C₁₀H₁₀ClN₃ | 147-148 |
| 65 | C₁₀H₇F₄N₃ | 121-122 |
| 66 | C₁₀H₁₀FN₃ | 105 |
| 67 | C₁₂H₁₄Cl₂N₄O₂S | 127-129 |
| 68 | C₁₂H₁₁Cl₂N₃O | 164-165 |
| 69 | C₁₄H₂₀Cl₂N₅OP | 94-96 |
| 70 | C₁₄H₂₀N₄O₂S | 94-95 |
| 71 | C₁₃H₁₈N₄O₂S | 58-59 |
| 72 | C₁₁H₁₃N₃ | 119-120 |
| 73 | C₁₂H₁₅N₃ | 144-145 |
| 74 | C₁₃H₁₃Cl₂N₃O₂ | 107-108 |
| 75 | C₁₃H₁₇ClN₄O₂S | 114-115 |
| 76 | C₁₁H₁₂ClN₃ | 150-151 |
| 77 | C₁₃H₁₄Cl₂N₄S | 75-76 |
| 78 | C₁₃H₁₄Cl₂N₄O | 70-71 |
| 79 | C₁₄H₁₇N₃O₂ | 117-118 |
| 80 | C₁₄H₁₇N₃O | 135-136 |
| 81 | C₁₂H₁₂F₄N₄O₂S | 72-73 |
| 82 | C₁₅H₁₉N₃O₂ | 77-78 |
| 83 | C₁₆H₂₄N₃O₃P | OIL |
| 84 | C₁₅H₂₀N₄O | OIL |
| 85 | C₁₆H₂₁N₃O₂ | 100-101 |
| 86 | C₁₆H₂₆N₅OP | OIL |
| 87 | C₁₅H₁₉N₃O | 127-128 |
| 88 | C₁₆H₂₁N₃O | 71-72 |
| 89 | C₁₅H₂₀N₄O | OIL |
| 90 | C₁₄H₁₈N₄O | 121-122 |
| 91 | C₁₃H₁₇N₃O₂S | 141-142 |
| 92 | C₁₆H₂₁N₃O₂ | 103-104 |
| 93 | C₁₇H₂₃N₃O₂ | 123-124 |
| 94 | C₁₇H₂₃N₃O₂ | 82-83 |
| 95 | C₁₆H₁₇N₃O₂ | 87-88 |
| 96 | C₁₄H₁₉N₃O | OIL |
| 97 | C₁₈H₂₅N₃O | 121-122 |
| 98 | C₁₈H₁₄F₅N₃O₂S | 127-128 |
| 99 | C₁₈H₂₅N₃O | 116-117 |
| 100 | C₁₉H₁₄F₅N₃O | 108-109 |
| 101 | C₁₇H₂₃N₃O | 103-104 |
| 102 | C₁₇H₂₃N₃O | 123-124 |
| 103 | C₁₃H₁₄F₃N₃O₂S | 124-125 |
| 104 | C₁₅H₂₁N₃O | OIL |
| 105 | C₁₃H₁₇N₃ | 99-100 |
| 110 | C₂₀H₂₇N₃O₄ | OIL |
| 111 | C₁₄H₁₈N₄S | 189-190 |
| 112 | C₁₃H₁₅N₃O | OIL |
| 113 | C₂₄H₂₇N₃O₄ | OIL |
| 114 | C₁₀H₉Cl₂N₃ | 170-171 |
| 115 | C₁₂H₁₅N₃ | SOLID |

Candidate insecticides were evaluated for insecticidal activity by observing mortality in a population of cotton aphid (Aphis gossypii) on treated cotton plants when compared to like populations of cotton aphid on untreated plants. These tests were conducted in the following manner:

For each rate of application of test compound, two seven-to-ten days old cotton seedlings (Gossypium hirsutium) grown in 7.6 cm diameter pots were selected for the test. Each test plant was infested with about 120 adult cotton aphids by placing onto each test plant cuttings of leaves from cotton plants grown in a cotton aphid colony. Once infested, the test plants were maintained for up to about 12 hours to allow complete translocation of the aphids onto the test plant. A solution comprising 1000 part per million (ppm) of each test compound was prepared by dissolving 10 milligrams of the test compound in 1 mL of acetone. Each solution was then diluted with 9 mL of a solution of 0.03 mL of polyoxyethylene(10) isooctylphenyl ether in 100 mL of water. About 2.5 mL of solution of each test compound was needed to spray each replicate of test plant (5 mL total for each test compound). If needed, the solution of 1000 ppm of test compound was serially diluted with a solution of 10% acetone and 300 ppm of polyoxyethylene(10) isooctylphenyl ether in water to provide solutions of each test compound for lower rates of application, for example, 300 ppm, 100 ppm, 30 ppm, or 10 ppm. Each replicate of test plant was sprayed with the solutions of test compound until run-off on both the upper and lower surfaces of the leaves. All the test plants were sprayed using a DeVilbus Atomizer Model 152 (Sunrise Medical, Carlsbad, Calif.) at a pressure of about 0.63-0.74 kilogram per square centimeter from a distance of about 30.5 centimeters from the test plants. For comparison purposes, a solution of a standard, such as amitraz or demethylchlordimeform (DCDM), prepared in a manner analogous to that set forth above, as well as a solution of 10% acetone and 300 ppm of polyoxyethylene(10) isooctylphenyl ether in water containing no test compound were also sprayed onto test plants. Upon completion of spraying the solutions of test compound, the solution of standard, and the solution containing no test compound, the plants were allowed to dry. Upon completion of drying, the test plants were placed in a tray containing about 2.5 centimeters of water, where they were maintained in a growth chamber for at least 24 hours. After this time, each plant was assessed for percent mortality caused by the test compound when compared to the population of aphids that was infested onto the test plants prior to treatment with test compound. A test compound was designated as possessing insecticidal activity (SA) if there was 40% to 75% mortality of cotton aphid on plants sprayed with that compound. If there was 75% mortality or greater of the cotton aphid, a test compound was designated as being more insecticidally active (A). If there was 40% mortality or less of the cotton aphid, the test compound was termed as inactive (I).

An assessment of the insecticidal activity at selected rates of application from this test is provided in Table 3. The test compounds of formula I are identified by numbers that correspond to those in Table 1.

TABLE 3
The Following Compounds Of The Present Invention Reduced
The Population Of Cotton Aphid Between 40% And 100% When
Applied At An Application Rate Of 300 ppm Or Less

| Cmpd. | Cmpd. | Cmpd. | Cmpd. | Cmpd. | Cmpd. | Cmpd. | Cmpd. | Cmpd. | Cmpd. |
|---|---|---|---|---|---|---|---|---|---|
| No. | No. | No. | No. | No. | No. | No. | No. | No. | No. |
| 1 | 2 | 6 | 7 | 8 | 9 | 10 | 11 | 12 | 13 |
| 14 | 15 | 16 | 17 | 18 | 19 | 20 | 21 | 22 | 23 |
| 24 | 25 | 26 | 27 | 28 | 29 | 30 | 31 | 32 | 33 |
| 34 | 35 | 36 | 37 | 38 | 39 | 40 | 41 | 42 | 43 |
| 44 | 45 | 46 | 47 | 48 | 50 | 51 | 52 | 57 | 58 |
| 59 | 60 | 61 | 62 | 63 | 64 | 65 | 66 | 67 | 68 |
| 69 | 70 | 71 | 72 | 73 | 74 | 75 | 76 | 77 | 78 |
| 79 | 80 | 81 | 82 | 83 | 84 | 85 | 86 | 87 | 88 |
| 89 | 90 | 91 | 92 | 93 | 94 | 95 | 96 | 97 | 98 |
| 99 | 100 | 101 | 102 | 103 | 104 | 105 | 110 | 111 | 112 |
| 113 | 114 | 115 | | | | | | | |

As set forth in Table 3, most of the tested compounds of the present invention reduced the aphid population by at least 40% at an application rate of 300 ppm or less.

Candidate insecticides were also evaluated for cotton aphid insecticidal activity by observing mortality in a population of cotton aphid (Aphis gossypii) on treated cotton plant leaf discs when compared to like populations of cotton aphid on untreated plant leaf discs. These tests were conducted in the following manner:

Three week to one month-old cotton plants (Gossypium hirsutium) were prepared for infesting by cutting off the cotyledons and new true leaf growth, leaving the oldest two true leaves. To infest, two seven-to-ten day old cotton plants, grown in a cotton aphid colony were uprooted and lodged in the apex of the stem where the stems of the two true leaves meet with the main stem. Once infested, the test plants were maintained for up to about 12 hours to allow complete translocation of the aphids onto the leaves of the test plant. The wells of clear 128-well trays (CD-International, Pittman, N.J.) were filled with 1 mL of a warm, aqueous 3% agar solution and allowed to cool to ambient temperature. The aphid infested cotton leaves were removed from the plants and placed bottom side up on a cutting platform. Circular discs were cut from the infested leaves and placed bottom side up onto the cooled agar gel, one disc per well. Each leaf disc was visually inspected to assure that a minimum of 10 live aphids were present. A 50 mM stock solution of the test compound was prepared by dissolving the appropriate amount of the test compound in DMSO. A solution comprising 1000 part per million (ppm) of each test compound was prepared by dissolving 10 μl of the stock solution in 140 μl of an aqueous 0.003% Kinetic® (a nonionic wetter/spreader/penetrant adjuvant) solution. If needed, the solution of 1000 ppm of test compound was serially diluted with a solution of 66 mL of DMSO and 30 μl of Kinetic® in 934 mL of water (diluting solution) to provide solutions of each test compound for lower rates of application, for example, 300 ppm, 100 ppm, 30 ppm, or 10 ppm. Each replicate test plant disc was sprayed with 10 μl of the test solution at about 8 psi for 1 second. For comparison purposes, an aqueous solution of 0.003% Kinetic® containing no test compound and the diluting solution containing no test compound were also sprayed onto test plant discs. Upon completion of spraying the solutions of test compound and the solutions containing no test compound, the plant discs were allowed to dry. Upon completion of drying, the test trays were covered with a plastic film. Three slits were made in the film over each well to allow air into each well. The test trays were placed in a biochamber (25° C., 16 hours light, 8 hours of dark and 35-40% relative humidity) for three days. After this time, each plant disc was assessed for percent mortality caused by the test compound when compared to the population of aphids that was infested onto the test plant discs containing no test compound. A test compound was designated as possessing insecticidal activity (SA) if there was 40% to 75% mortality of cotton aphid on discs sprayed with that compound. If there was 75% mortality or greater of the cotton aphid, a test compound was designated as being more insecticidally active (A). If there was 40% mortality or less of the cotton aphid, the test compound was termed as inactive (I).

An assessment of the insecticidal activity at selected rates of application from this test is provided in Table 3A. The test compounds of formula I are identified by numbers that correspond to those in Table 1.

TABLE 3A
The following Compounds of The Present Invention Reduced the
Population of Cotton Aphid on Treated Leaf Disks by 40% to 100%
when Applied at an Application Rate of 300 ppm or Less

| Cmpd. No. | Cmpd. No. | Cmpd. No. | Cmpd. No. |
|---|---|---|---|
| 3 | 4 | 5 | 49 |

Candidate insecticides were evaluated for insecticidal activity by observing mortality in a population of silverleaf whitefly (Bemisia argentifolii) on treated cotton plant cotyledons when compared to like populations of silverleaf whitefly on untreated plant cotyledons. These tests were conducted in the following manner:

For each rate of application of test compound, two four to six days old cotton seedlings (Gossypium hirsutium) grown in 3-inch diameter pots were selected for the test. Each test plant was sprayed with a test solution comprising 300 part per million (ppm), or less, of each test compound prepared by dissolving 12 milligrams of the test compound in 4 mL of acetone. Each solution was then diluted with 36 mL of a surfactant and water solution prepared by dissolving 0.03 gm of Triton X-100® surfactant in 100 mL of distilled water, providing a stock test solution of 300 ppm. About 2.5 mL of solution of each test compound was needed to spray each replicate of test plant (5 mL total for each test compound). If needed, the solution of 300 ppm of test compound was diluted with a solution of 10% acetone and 300 ppm of Triton X-100® surfactant in water to provide solutions of each test compound for lower rates of application, for example, 100 ppm, 30 ppm, or 10 ppm. Each replicate of test plant was sprayed with the solutions of test compound until run-off on both the upper and lower surfaces of the leaves. All the test plants were sprayed using a DeVilbus Atomizer Model 152 (Sunrise Medical, Carlsbad, Calif.) at a pressure of about 0.63-0.74 kilogram per square centimeter from a distance of about 30.5 centimeters from the test plants. Upon completion of spraying the solutions of test compound and the solution containing no test compound, the plants were allowed to dry. Upon completion of drying, the test plants were excised at the soil surface and placed in a 1 ounce plastic cup containing a 2.5 cm filter paper moistened with 50 microliters of distilled water. Whiteflies (25-50) were added to each cup and a lid was placed on each. The test cups were maintained in a growth chamber for 72 hours at 70% relative humidity (light 12 hours/day). After this time, each test was assessed for percent mortality caused by the test compound when compared to the population of whiteflies that were infested onto the test plants. A test compound was designated as possessing insecticidal activity (SA) if there was 40% to 75% mortality of whiteflies on plants sprayed with that compound. If there was 75% mortality or greater of whiteflies, a test compound was designated as being more insecticidally active (A). If there was 40% mortality or less of the cotton aphid, the test compound was termed as inactive (I).

An assessment of the insecticidal activity at selected rates of application from this test is provided in Table 4. The test compounds of formula I are identified by numbers that correspond to those in Table 1.

TABLE 4
The following Compounds of The Present Invention Reduced the Population
of Silverleaf Whitefly (Bemisia argentifolii) by 40% to 100% When
Applied at an Application Rate of 300 ppm or Less

| Cmpd. | Cmpd. | Cmpd. | Cmpd. | Cmpd. | Cmpd. | Cmpd. | Cmpd. | Cmpd. | Cmpd. |
|---|---|---|---|---|---|---|---|---|---|
| No. | No. | No. | No. | No. | No. | No. | No. | No. | No. |
| 2 | 8 | 10 | 17 | 82 | 85 | 89 | 92 | 94 | 95 |
| 100 | 113 | | | | | | | | |

While this invention has been described with an emphasis upon preferred embodiments, it will be understood by those of ordinary skill in the art that variations of the preferred embodiments may be used and that it is intended that the invention may be practiced otherwise than as specifically described herein. Accordingly, this invention includes all modifications encompassed within the spirit and scope of the invention as defined by the following claims.

1. An insecticidal composition comprising a compound of formula Ia: 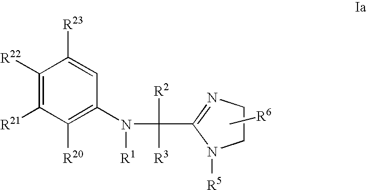
wherein
R¹ is hydrogen;
R² is hydrogen or (C₁-C₂)alkyl;
R³ is hydrogen;
R⁶ is hydrogen or (C₁-C₂)alkyl;
R⁵ is selected from the group consisting of hydrogen, cyano, (C₁-C₂)alkoxy(C₁-C₂)alkyl, 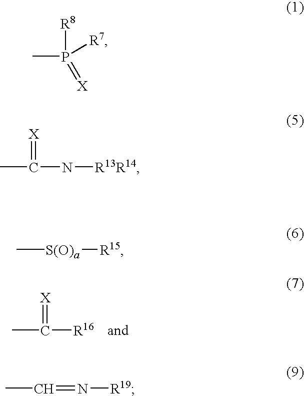
where
X is oxygen or sulphur;
R⁷ and R⁸ are (C₁-C₂)alkoxy or di(C₁-C₂)alkylamino;
R¹³ is hydrogen;
R¹⁴ is phenyl substituted with 1 to 2 chlorine atoms;
a is 2;
R¹⁵ is (C₁-C₂)haloalkyl;
R¹⁶ is hydrogen, (C₃-C₅)alkyl, methoxy, (C₁-C₂)alkoxycarbonyl(C₁-C₂)alkyl or phenyl optionally substituted in the 3-position with fluorine, chlorine or (C₁-C₂)alkoxy, or in the 4-position with (C₁-C₂)haloalkyl, (C₁-C₂)haloalkoxy, chlorine or (C₁-C₂)alkoxy;
R¹⁹ is (C₁-C₂)alkyl or (C₁-C₂)alkoxy;
R²⁰ is hydrogen, halogen or (C₁-C₂)alkyl;
R²¹ is hydrogen, halogen, (C₁-C₂)alkyl or (C₁-C₂)alkoxy;
R²² is hydrogen or halogen;
R²³ is hydrogen or (C₁-C₂)alkyl;
and
agriculturally acceptable salts thereof,
provided that at least one of R²⁰, R²¹, R²² and R²³ is other than hydrogen; and
when R¹, R², R³ and R⁶ are hydrogen, R⁵ is 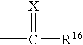
in which X is oxygen and the phenyl group attached to N is 2,3-dichlorophenyl, then R¹⁶ is other than 1-methylpropyl or methoxy;
when R¹, R², R³ and R⁶ are hydrogen, R⁵ is group 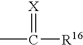
in which X is oxygen and the phenyl group attached to N is 2,3-dimethylphenyl, then R¹⁶ is other than methoxycarbonylmethyl; and
when R¹, R², R³, R⁵ and R⁶ are hydrogen, then the phenyl group attached to N is other than 2-methylphenyl or 4-chloro-2-methylphenyl and the hydrochloride salt thereof.

2. An insecticidal composition as claimed in claim 1, comprising a compound of formula Ia in which:
R²⁰ and R²¹ are chlorine; and R⁵ is cyano, ethoxymethyl, or hydrogen; and or
R²⁰ and R²¹ are chlorine, R⁵ is 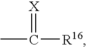
in which X is oxygen and R¹⁶ is hydrogen, phenyl or 4-trifluoromethoxyphenyl.

3. An insecticidal composition comprising a compound of formula Ib: 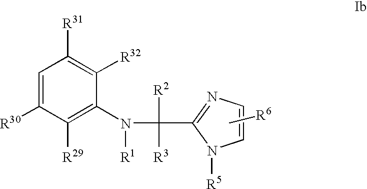
wherein
R¹ is hydrogen, 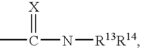
in which X is sulfur, R¹³ is hydrogen and R¹⁴ is (C₁-C₂)alkyl, or 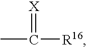
in which X is oxygen and R¹⁶ is hydrogen or (C₁-C₄)alkoxy;
R² and R³ are hydrogen;
R⁶ is hydrogen;
R⁵ is selected from the group consisting of hydrogen, (C₁-C₂)alkoxy(C₁-C₂)alkyl, benzyloxycarbonyl(C₁-C₄)alkoxy, 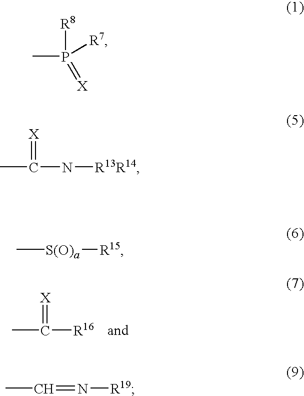
where
X is oxygen or sulphur;
R⁷ and R⁸ are (C₁-C₂)alkoxy or di(C₁-C₂)alkylamino;
R¹³ is hydrogen or (C₁-C₂)alkyl;
R¹⁴ is hydrogen, (C₁-C₅)alkyl, (C₃-C₆)cycloalkyl, (C₁-C₂)alkoxy(C₁-C₂)alkyl, cyano(C₁-C₂)alkyl, (C₁-C₂)alkoxycarbonyl(C₁-C₂)alkyl;
a is 2;
R¹⁵ is (C₁-C₂)haloalkyl, di(C₁-C₂)alkylamino or pentafluorophenyl;
R¹⁶ is hydrogen, (C₁-C₅)alkyl, (C₁-C₅)alkoxy, (C₁-C₂)alkylamino, pentafluorophenyl, (C₃-C₅)alkynyl or benzyloxycarbonyl(C₁-C₄)alkoxy;
R¹⁹ is (C₁-C₂)alkyl or alkoxy;
R²⁹ and R³⁰ are halogen or (C₁-C₂)alkyl; and
R³¹ and R³² are each hydrogen or halogen;
and
agriculturally acceptable salts thereof.

4. An insecticidal composition as claimed in claim 3, comprising a compound of formula Ib where:
R²⁹ and R³⁰ are methyl and R⁵ is 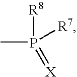
in which X is oxygen and R⁷ and R⁸ are ethoxy; or
R²⁹ and R³⁰ are methyl and R⁵ is 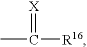
in which X is oxygen and R¹⁶ is alkyl of 1 to 5 carbon atoms, alkoxy of 2 to 4 carbon atoms or 3-propynyloxy; or
R⁵ is hydrogen and R²⁹ and R³⁰ are methyl or chlorine.

5. An insecticidal composition comprising a compound of formula Ic: 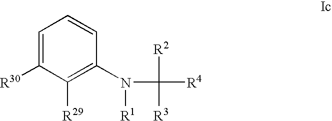
wherein
R¹, R² and R³ are hydrogen;
R⁴ is selected from the group consisting of 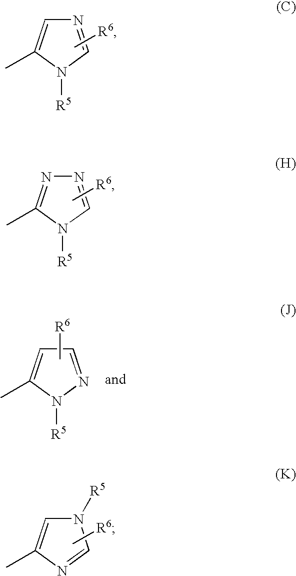
R⁶ is hydrogen;
R⁵ is selected from the group consisting of hydrogen, 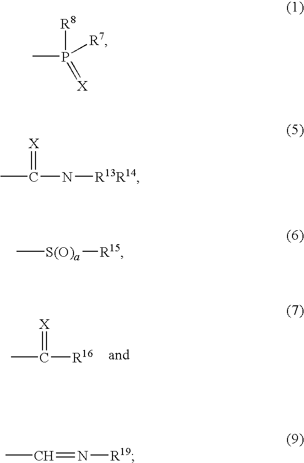
where
X is oxygen or sulphur;
R⁷ and R⁸ are (C₁-C₂)alkoxy;
R¹³ is hydrogen;
R¹⁴ is (C₁-C₂)alkyl;
a is 2;
R¹⁵ is di(C₁-C₂)alkylamino;
R¹⁶ is hydrogen, (C₁-C₂)alkyl or (C₁-C₂)alkoxy;
R¹⁹ is (C₁-C₂)alkyl or (C₁-C₂)alkoxy;
R²⁹ and R³⁰ are independently selected from halogen a or (C₁-C₂)alkyl;
and
agriculturally acceptable salts thereof.

6. An insecticidal composition as claimed in claim 1, further comprising one or more additional compounds selected from the group consisting of pesticides, plant growth regulators, fertilizers and soil conditioners.

7. An insecticidal composition as claimed in claim 3, further comprising one or more additional compounds selected from the group consisting of pesticides, plant growth regulators, fertilizers and soil conditioners.

8. An insecticidal composition as claimed in claim 5, further comprising one or more additional compounds selected from the group consisting of pesticides, plant growth regulators, fertilizers and soil conditioners.

9. A method of controlling insects, comprising contacting said insects or their habitat with a composition of claim 1.

10. (canceled)

11. A method of controlling insects, comprising contacting said insects or their habitat with a composition of claim 3.

12. A method of controlling insects, comprising a contacting said insects or their habitat with a composition of claim 5.

13. A compound of formula Id: 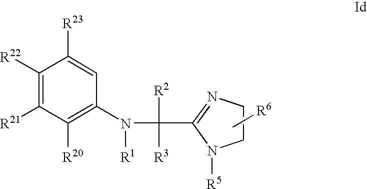
wherein
R¹ is hydrogen;
R² is hydrogen or (C₁-C₂)alkyl;
R³ is hydrogen;
R⁶ is hydrogen or (C₁-C₂)alkyl;
R⁵ is selected from the group consisting of cyano, (C₁-C₂)alkoxy(C₁-C₂)alkyl, 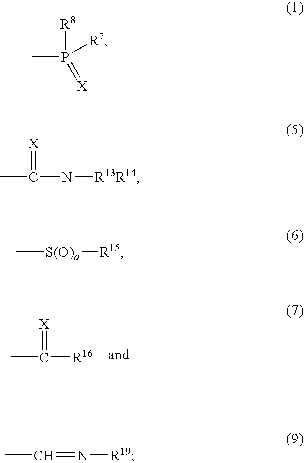
where
X is oxygen or sulphur;
R⁷ and R⁸ are (C₁-C₂)alkoxy or di(C₁-C₂)alkylamino;
R¹³ is hydrogen;
R¹⁴ is phenyl substituted with 1 to 2 chlorine atoms;
a is 2;
R¹⁵ is (C₁-C₂)haloalkyl;
R¹⁶ is hydrogen, (C₃-C₅)alkyl, methoxy, (C₁-C₂)alkoxycarbonyl(C₁-C₂)alkyl or phenyl optionally substituted in the 3-position with fluorine, chlorine or (C₁-C₂)alkoxy, or in the 4-position with (C₁-C₂)haloalkyl, (C₁-C₂)haloalkoxy, chlorine or (C₁-C₂)alkoxy;
R¹⁹ is (C₁-C₂)alkyl or (C₁-C₂)alkoxy;
R²⁰ is hydrogen, halogen or (C₁-C₂)alkyl;
R²¹ is hydrogen, halogen, (C₁-C₂)alkyl or (C₁-C₂)alkoxy;
R²² is hydrogen or halogen;
R²³ is hydrogen or (C₁-C₂)alkyl; and
agriculturally acceptable salts thereof;
provided that:
at least one of R²⁰, R²¹, R²² and R²³ is other than hydrogen;
when R¹, R², R³ and R⁶ are hydrogen, R⁵ is 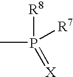
in which X is oxygen and R⁷ and R⁸ are alkoxy, then the phenyl group attached to N is other than 2,3-dichlorophenyl and 2,3-dimethylphenyl;
when R¹, R², R³ and R⁶ are hydrogen, R⁵ is 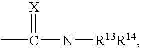
in which X is oxygen, R¹³ is hydrogen and R¹⁴ is phenyl substituted with halogen, then the phenyl group attached to N is other than 2-fluorophenyl and 2,3-dimethylphenyl;
when R¹, R², R³ and R⁶ are hydrogen and R⁵ is methoxyethyl, then the phenyl group attached to N is other than 2,3-dimethylphenyl;
when R¹, R², R³ and R⁶ are hydrogen, R⁵ is 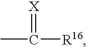
in which X is oxygen and the phenyl group attached to N is 2,3-dichlorophenyl, then R¹⁶ is other than 1-methylpropyl or methoxy; and
when R¹, R², R³ and R⁶ are hydrogen, R⁵ is 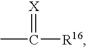
in which X is oxygen and the phenyl group attached to N is 2,3-dimethylphenyl, then R¹⁶ is other than methoxycarbonylmethyl.

14. A compound of formula Ie: 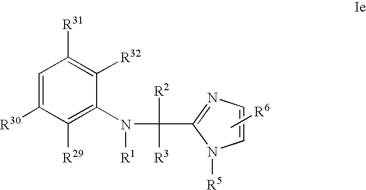
wherein
R¹ is hydrogen, 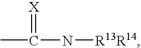
in which X is sulfur, R¹³ is hydrogen and R¹⁴ is (C₁-C₂)alkyl or 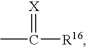
wherein X is oxygen and R¹⁶ is hydrogen or (C₁-C₄)alkoxy;
R² and R³ are hydrogen;
R⁶ is hydrogen;
R⁵ is selected from the group consisting of hydrogen, (C₁-C₂)alkoxy(C₁-C₂)alkyl, benzyloxycarbonyl(C₁-C₄)alkoxy, 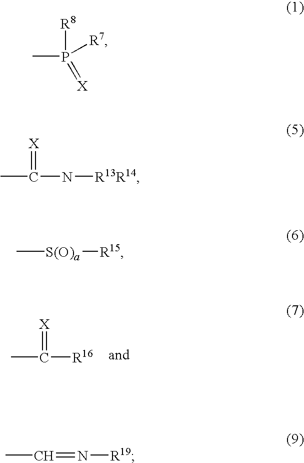
where
X is oxygen or sulphur;
R⁷ and R⁸ are (C₁-C₂)alkyl, (C₁-C₂)alkoxy or di(C₁C₂)alkylamino;
R¹³ is hydrogen or (C₁-C₂)alkyl;
R¹⁴ is hydrogen, (C₁-C₅)alkyl, (C₃-C₆)cycloalkyl, (C₁-C₂)alkoxy(C₁-C₂)alkyl, cyano(C₁-C₂)alkyl, or (C₁-C₂)alkoxycarbonyl(C₁-C₂)alkyl;
a is 2;
R¹⁵ is (C₁-C₂)haloalkyl, di(C₁-C₂)alkylamino or pentafluorophenyl;
R¹⁶ is hydrogen, (C₁-C₅)alkyl, (C₁-C₅)alkoxy, (C₁-C₂)alkylamino, pentafluorophenyl, (C₃-C₅)alkynyl or benzyloxycarbonyl(C₁-C₄)alkoxy; and
R¹⁹ is (C₁-C₂)alkyl or alkoxy;
R²⁹ and R³⁰ are halogen or (C₁-C₂)alkyl;
R³¹ and R³² are hydrogen or halogen;
and
agriculturally acceptable salts thereof;
provided that:
when R¹, R², R³, R⁵ and R⁶ are hydrogen, then the phenyl group attached to N is other than 2,3-dimethylphenyl or 3-chlorophenyl.

15. A compound of formula If: 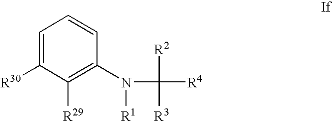
wherein
R¹, R² and R³ are hydrogen;
R⁴ is selected from the group consisting of 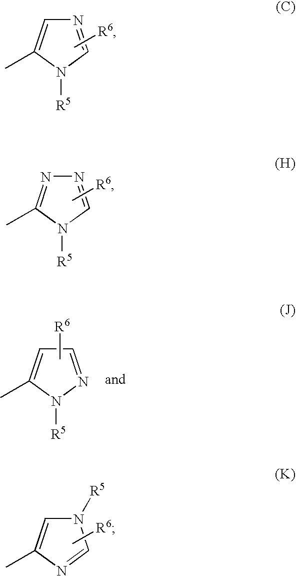
R⁶ is hydrogen;
R⁵ is selected from the group consisting of hydrogen, 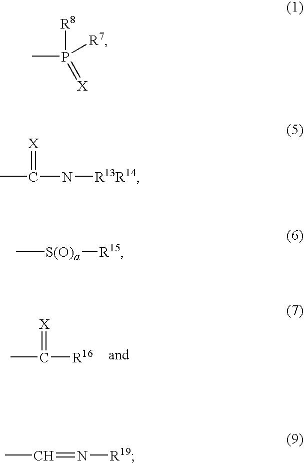
where
X is oxygen or sulphur;
R⁷ and R⁸ are (C₁-C₂)alkoxy;
R¹³ is hydrogen;
R¹⁴ is (C₁-C₂)alkyl;
a is 2;
R¹⁵ is di(C₁-C₂)alkylamino;
R¹⁶ is hydrogen, (C₁-C₂)alkyl or (C₁-C₂)alkoxy;
R¹⁹ is (C₁-C₂)alkyl or (C₁-C₂)alkoxy;
R²⁹ and R³⁰ are independently halogen or (C₁-C₂)alkyl;
and
agriculturally acceptable salts thereof.

16. An insecticidal composition comprising a compound of claim 13.

17. An insecticidal composition comprising a compound of claim 14.

18. An insecticidal composition comprising a compound of claim 15.

19. A method of controlling insects, comprising contacting said insects or their habitat with a composition of claim 16.

20. A method of controlling insects, comprising contacting said insects or their habitat with a composition of claim 17.

21. A method of controlling insects, comprising contacting said insects or their habitat with a composition of claim 18.
